(19) United States
(12) Patent Application Publication
(10) Pub. No.: US 2014/0059069 A1
(43) Pub. Date: Feb. 27, 2014

(54) Parallel Filter Method and User Interface for Student Database Searching

(71) Applicants: Michael William Taft, Dallas, TX (US); Christopher Guilbeau, Austin, TX (US); Rod Mancisidor, Austin, TX (US)

(72) Inventors: Michael William Taft, Dallas, TX (US); Christopher Guilbeau, Austin, TX (US); Rod Mancisidor, Austin, TX (US)

(21) Appl. No.: 13/590,494

(22) Filed: Aug. 21, 2012

(51) Int. Cl. G06F 17/30

(52) U.S. Cl. CPC G06F 17/30442
USPC 707/765

(57) ABSTRACT

What is provided is a system, user interface and computer implemented method of building a customized query for a student database. The query is built using filtering criteria and parameters associated thereto, which may be in natural language, yet capable of implementing BOOLEAN or set theory searching functionality without requiring user knowledge of such functionality. Query results may be modified without rebuilding the query, by adding a further filtering criteria and/or parameter, or removing a filter and/or parameter.

### FIELD

This patent application relates to filtered searching of a database, such as a student database.

### BACKGROUND

Database searching techniques are known, such as BOOLEAN searching, keyword searching, set theory searching, SQL searching and the like. For databases having large volumes of information and/or having many fields of information for or associated with each database item, efficient searching techniques are desired for organization, manipulation and use of the data contained therein. Yet, efficient searching techniques are lacking if a user attempting to apply search criteria is not sure how to perform the searching or does not understand the syntax or filter requirements. Efficient searching techniques are lacking if a search must be entirely rebuilt in order to be edited to remove searching parameters. Efficient searching techniques are lacking if they are not customizable for a user's needs.

For databases, such as databases for student enrollment information that are to be used by faculty, administration or students, providing a user friendly searching user interface and searching technique is desired. This is particularly true for non-technical users who seek to search the database but may not be familiar with BOOLEAN, set theory, or other technical searching or search filtering methods.

Attempting to use technically difficult searching filters, which may have filters or searching parameters requiring complex or specific syntax or which employ language or logic not intuitive to a user, may lead to user frustration, take significant time to complete searching tasks, or result in erroneous search results or hits. Similarly, misuse of such searching filters or parameters may return false or incomplete results. For example, a user employing erroneous syntax for a BOOLEAN search may receive zero results or hits for a search, not based upon lack of data entries meeting the desired criteria, but based upon erroneous syntax used for the search. Similarly, a user applying hierarchically designed filters may end up with different results based upon the order of the searching filters used. In this manner, and others, searching techniques requiring technical search filters or terms may result in false, erroneous, inconsistent, misleading or incomplete results based upon user error with employing syntax or search terms or filters.

A further problem with database searching can exist where a user is not given choices of combinations of searching parameters that the user desires for the search. This can happen in searching environments with pre-set search criteria or parameters arranged into pre-set or hierarchical layers. Similarly, searching that is not customizable by a user may result in the system lacking the searching functionality desired by a user for a particular search.

In the student database context, a common action performed by institutional researchers, advisors and others is to find a group of students. This is normally done in close proximity to the user generating a report for those students or contacting the students.

In its simplest form, the action desired is to simply find a specific student or a small group of students, such as all the students enrolled in a given class or pursuing a given major or who have not registered for this term yet. This is but one simple example of information desired from the database. Very quickly the selection of students may become more complicated. For example, a user may want to identify all students who have not registered yet, but may want to exclude students who graduated already since they would not ordinarily necessarily be expected to return to the institution for classes. For example, a user may want to identify all students who have not registered yet, who also have not yet graduated, who have completed a particular class, who are male, and who have a grade point average greater than 3.0, etc. In this sense, queries may be desired which involve more than one search term or parameter and/or more than one limit. However, for users not versed in technical search query language, building such a search may be very difficult.

### SUMMARY

What is provided is a user interface and method for searching a database, such as a student database, that employs flat (rather than hierarchical) searching filters and that includes user friendly language terms for searching, rather than complex logical or technical terms which may be unknown to lay person users who are not technically trained in such complex searching methods.

What is provided is a student navigator user interface designed to allow users to find groups of students using potentially complex criteria without requiring technical knowledge of a query language. An objective is to allow users to access the simplest or most frequently performed queries with a few clicks, while still allowing for potentially very complex queries using the same interface, but without requiring user knowledge of complex query language.

What is provided is a user interface for non-technical users to search a database of student information. Users may custom build search inquiries by setting search filters to form a multilayered query. Search filters may include various database entries regarding student information, such as enrollment status, grades, courses, credits completed, etc. Filters may be written in natural language and then combined to create an aggregate filter and/or criteria that are readable by a lay person, as in the examples discussed above. A user may elect to use a filter by clicking on it and may set parameters, such as “any” or “all” and “do” or “don't” to tailor search results. Filters may be individually changed or deleted without having to rebuild the search. Each filter acts as a building block. The user interface makes complex BOOLEAN, set theory or other searches user friendly for non-technical users and allows users to search voluminous academic record documents in an easy manner by having pre-set filters (based upon common search criteria) available for selection, as well as by allowing the user to customize the search. Search results may be viewed and saved as criteria and/or a list of hits.

What is provided is a user interface having one or more sets of predefined category search filters. The search filters can be refined internally with predefined sub-filters. The selected search filters/sub-filters can be refined externally (with respect to one another) with non-BOOLEAN (non-filter-joining, independent, parallel) search operators, such as “do”, “don't”, “any”, “all”, etc. A query comprising one or more selected filters may be modified by deleting, adding to, and/or refining one or more of the selected filters without impacting the form/content of the other filters and then applied by simply refreshing the search. In this manner, the search need not be completely rebuilt to add or remove a filter, and the filters independently filter information without regard to any hierarchy. Similarly, in this manner, since each filter is separate (like a separate building block), a user may add one or more filters to the search without having knowledge of any other existing filter. In this sense, the filters may be independent and any filter may work with any other filter.

### BRIEF DESCRIPTION OF THE DRAWINGS

Subject matter is particularly pointed out and distinctly claimed in the concluding portion of the specification. Claimed subject matter, however, as to structure, organization and method of operation, together with objects, features, and advantages thereof, may best be understood by reference to the following detailed description if read with the accompanying drawings in which:

FIG. 1 is user interface diagram in accordance with one or more student navigator embodiments of this application;

FIG. 2 is a user interface diagram in accordance with one or more embodiments showing a user's initial visit to the query database;

FIG. 3 is a user interface diagram in accordance with one or more embodiments of this application showing filter functionality;

FIG. 4 is a user interface diagram in accordance with one or more embodiments showing functionality for identifying a universal set;

FIG. 5 is a user interface diagram in accordance with one or more embodiments of this application showing pop-up filters and alerts;

FIG. 6 is a user interface diagram in accordance with one or more embodiments of this application showing functionality for filters and parameters;

FIG. 7 is a user interface diagram in accordance with one or more embodiments showing functionality for negation control;

FIG. 8 is a user interface diagram in accordance with one or more embodiments showing functionality for an “ANY” control;

FIG. 9 is a user interface diagram in accordance with one or more embodiments showing functionality for saving searches;

FIG. 10 is a user interface diagram in accordance with one or more embodiments showing information icon functionality;

FIG. 11 is a user interface diagram in accordance with one or more embodiments showing functionality for displaying saved search criteria;

FIG. 12 is a user interface diagram in accordance with one or more embodiments showing functionality for displaying saved search list;

FIG. 13 is a user interface diagram showing table filter functionality in accordance with one or more embodiments of the present application;

FIG. 14 is a user interface diagram showing table filter functionality in accordance with one or more embodiments of the present application;

FIG. 15 is a user interface diagram showing relational parameter functionality in accordance with one or more embodiments of the present application;

FIG. 16 is a user interface diagram showing parameter selection functionality with a set list of parameters in accordance with one or more embodiments of the present application;

FIG. 17 is a user interface diagram showing functionality for type recognized input for selecting filter parameters in accordance with one or more embodiments of the present application;

FIG. 18 is a user interface diagram displaying functionality for type recognized input for selecting filter parameters in accordance with one or more embodiments of the present application;

FIG. 19 is a user interface diagram displaying selected filters in accordance with one or more embodiments of the present application;

FIG. 20 is a user interface diagram displaying functionality for calling a universal set of parameters in accordance with one or more embodiments of the present application;

FIG. 21 is a user interface diagram displaying calendar functionality in accordance with one or more embodiments of the present application;

FIG. 22 is a user interface diagram displaying an example query built in accordance with one or more embodiments of the present application;

FIG. 23 is a user interface diagram showing an active filter field is accordance with one or more embodiments of the present application;

FIG. 24 is a user interface diagram showing an SQL toggle in accordance with one or more embodiments of the present application;

FIG. 25 is a print out of a report showing SQL statements corresponding to filters selected in FIG. 23 in accordance with an embodiment of the present application;

FIG. 26 is a user interface diagram of a query filter functionality embodiment of the present application;

FIG. 27 is a system diagram showing a system architecture embodiment in accordance with the present application;

FIG. 28 is a print out of a report showing an update to a filter for an instance of a user using the system for a first time in accordance with an embodiment of the present application;

FIG. 29 is a print out of a report showing results of clicking on a “Enrolled in current term” filter (which has no parameters) in accordance with an embodiment of the present application;

FIG. 30 is a flow chart showing an embodiment of a method of updating one or more filters and/or parameters in accordance with a method of the present application;

FIG. 31 is a system diagram of a computing system embodiment that may be used with the user interface, system and methods described in this application;

FIG. 32 is a block diagram of a computing platform embodiment that may be used with the user interface, system and methods described in this application; and

FIG. 33 is a flow chart showing a method of building a query in accordance with one or more embodiments of the present application.

### DETAILED DESCRIPTION

In the following detailed description, numerous specific details are set forth in order to provide a thorough understanding of the invention as defined in the claimed subject matter, and as an example of how to make and use the invention. However, it will be understood by those skilled in the art that claimed subject matter is not intended to be limited to such specific details and may even be practiced without requiring such specific details. In other instances, well-known methods, procedures, and components have not been described in detail so as not to obscure the invention defined by the claimed subject matter.

Some portions of the detailed description that follow are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here and generally considered to be a self-consistent sequence of operations and/or similar processing leading to a desired result. The operations and/or processing may involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device that manipulates and/or transforms data represented as physical electronic and/or magnetic quantities and/or other physical quantities within the computing platform's processors, memories, registers, and/or other information storage, transmission, and/or display devices.

Unless specifically stated otherwise, as apparent from the following discussion, it is appreciated that throughout this specification a computing platform includes, but is not limited to, a device such as a computer or a similar electronic computing device that manipulates and/or transforms data represented as physical, electronic and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof. Where it is described that a user instructs a computing platform to perform a certain action, it is understood that instructs may mean to direct or cause to perform a task as a result of a selection or action by a user. A user may, for example, instruct a computing platform to embark upon a course of action via an indication of a selection, including, for example, pushing a key, clicking a mouse, maneuvering a pointer, touching a touch screen, and/or by audible sounds. A user may, for example, input data into a computing platform such as by pushing a key, clicking a mouse, maneuvering a pointer, touching a touch pad, touching a touch screen, acting out touch screen gesturing movements, maneuvering an electronic pen device over a screen, verbalizing voice commands and/or by audible sounds. A user may include an end-user.

Flowcharts, also referred to as flow diagrams by some, are used in some figures herein to illustrate certain aspects of some embodiments. Logic they illustrate is not intended to be exhaustive of any, all, or even most possibilities. Their purpose is to help facilitate an understanding of this disclosure with regard to the particular matters disclosed herein. To this end, many well-known techniques and design choices are not repeated herein so as not to obscure the teachings of this disclosure.

Throughout this specification, the term system may, depending at least in part upon the particular context, be understood to include any method, process, apparatus, and/or other patentable subject matter that implements the subject matter disclosed herein.

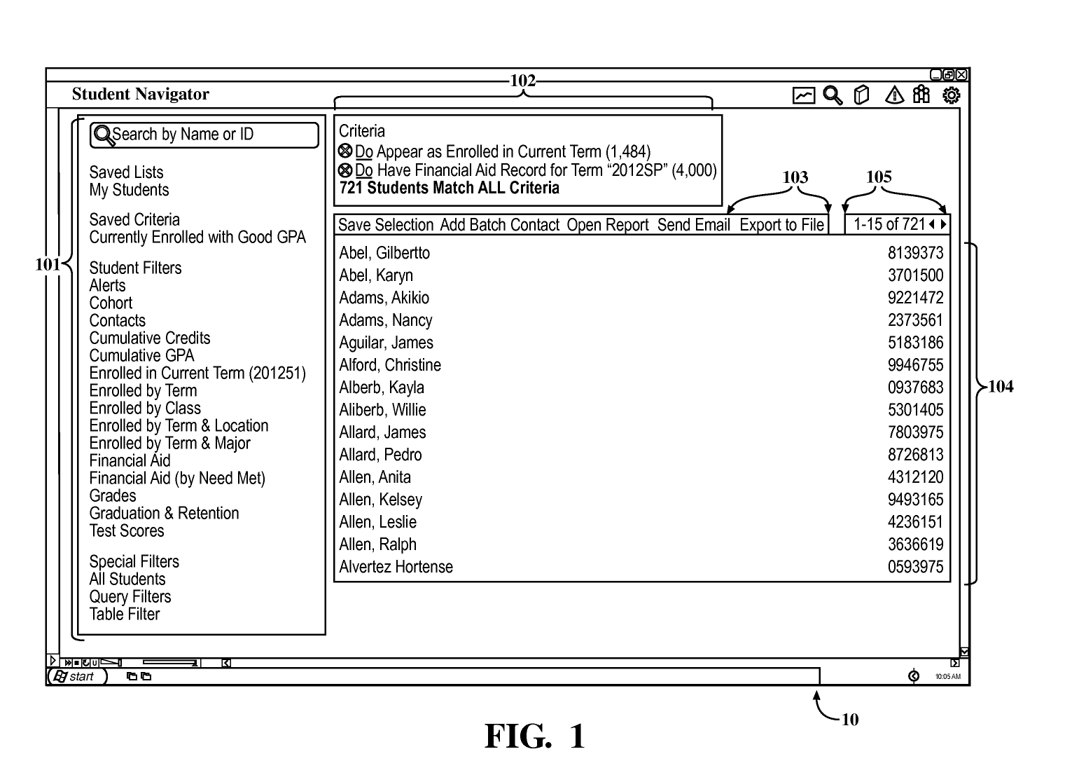

Referring to FIG. 1, a student navigator user interface embodiment is shown. User interface 10 is an example of screen graphics that may be displayed on a computing platform display to communicate database searching functionality to a user. User interface 10 contains field 101 displaying search filters available for a user to select to perform one or more database searches. By way of example, in a student database embodiment, search filters may include criteria such as student filters, including but not limited to, cumulative credits, cumulative GPA, enrolled in current term, enrolled by term, enrolled by class, enrolled by term and location, enrolled by term and major, financial aid, financial aid by need met, grades, graduation and retention, test scores, and many other possibilities. Filters may be customized for a particular application. Filters are generally composed of common search terms for information commonly sought in database queries. Filters are generally composed of natural language understandable by users not versed in technical database query language.

Filter options in field 101 may include special filters, such as but not limited to, an all students filter, a query filter and/or a table filter. These will be described in further detail below. Field 101 may also contain links to saved searches, such as saved criteria or saved lists generated by applying search criteria. Field 101 may also contain searching functionality for searching for a particular database hit. Searching functionality may be natural language or other searching. In this example, searching for student hits by name or ID is available. Other searching is possible, and searching may be customized in various applications of this functionality.

In this particular embodiment, field 101 is shown as a vertical menu. However, in various other embodiments, it could be displayed on user interface 10 in other manners, such as horizontal menu, pull down menu, tree, and the like. Claimed subject matter is not so limited.

A user may select filters in field 101 by clicking upon them or otherwise communicating information to the database, such as by keyboard, keypad, touch screen, stylus, or other communication protocols. Various means, methods, modes and manners are known in the art for a user to use a computing platform to communicate to a system selection of one or more items. Claimed subject matter is not intended to be limited to a particular hardware, software or other computer protocol for communication by a user.

The filters listed under “Student Filters” in field 101 may be commonly used filters. Some of them may provide a popup window for a user to provide additional information for query. For example, the Alerts filter may help a user find students who might be at risk.

User interface 10 also includes an active filter field 102. Active filter field 102 may identify all of the filters that are currently in effect. In various embodiments, it may contain one or more labels to identify the search criteria being employed. It may list each filter criteria in its entirety and/or in an abbreviated format. Filters in use may be identified pictorially or with icons associated with each filter. These are but possible examples of manners which active filter field 102 may identify filter criteria in use. In the particular example shown in FIG. 1, the filter criteria being applied as shown in active filter field 102 has a cardinality of 721 students. In this particular embodiment, active filter field 102 is shown as a vertical menu. However, in various other embodiments, it could be displayed on user interface 10 in other manners, such as horizontal menu, pull down menu, tree, and the like. The manner of identifying filters selected and manner of display may be customized in various embodiments. Claimed subject matter is not so limited.

User interface 10 contains a set of actions field 103, which lists actions available which could be applied to the list of query hits (in this example, the 721 students identified with the criteria selected). In this particular example, set of actions field 103 is a horizontal menu. But in other embodiments, it may a vertical list, pull down menu, tree or other manner known in the art for displaying a menu of available actions. Claimed subject matter is not so limited.

Actions listed in set of actions field 103 may consist of various options. In this particular student database example, a user may select actions, including save selection, add batch contact, open report, send email, and export to file. These are the options available to the user within the database for using the data to generate a further action by the database. These actions, including building reports, are decoupled from the selection and querying of database items. Actions may be customized for various embodiments, and these are merely sample actions possible with the database querying of the present application. Other actions are possible within the scope and spirit of this application.

User interface 10 contains query hit field 104. In this particular embodiment, it contains a partial listing of the 721 students meeting the filter criteria, as shown in active filter field 102. In this particular example, it identifies the student query hits by name and student identification number, but other identifying information may be used to characterize the query hits in various embodiments. For example, there may be displayed an aggregate report of students selected showing a distribution by ethnicity.

In this particular embodiment, query hits field 104 lists the search hits in a vertical menu, but other manners of displaying query hits known in the art are possible within the scope and spirit of this application. Claimed subject matter is not so limited.

User interface 10 contains page control field 105. Page control field 105 contains functionality for allowing a user to scroll through query hits in query hits field 104, such as to “page up” and/or “page down” through the list of hits. In this particular example, a user may move through pages of hits by selecting right and/or left arrows to move to “next” or “back” pages. Other page delineations are possible within the scope of this application, such as functionality allowing a user to select a page by its number. Claimed subject matter is not so limited. Page control field 105 may be employed if the listing of query hits in query hits field 104 is larger than that which may be simultaneously displayed to a user on a computing platform screen.

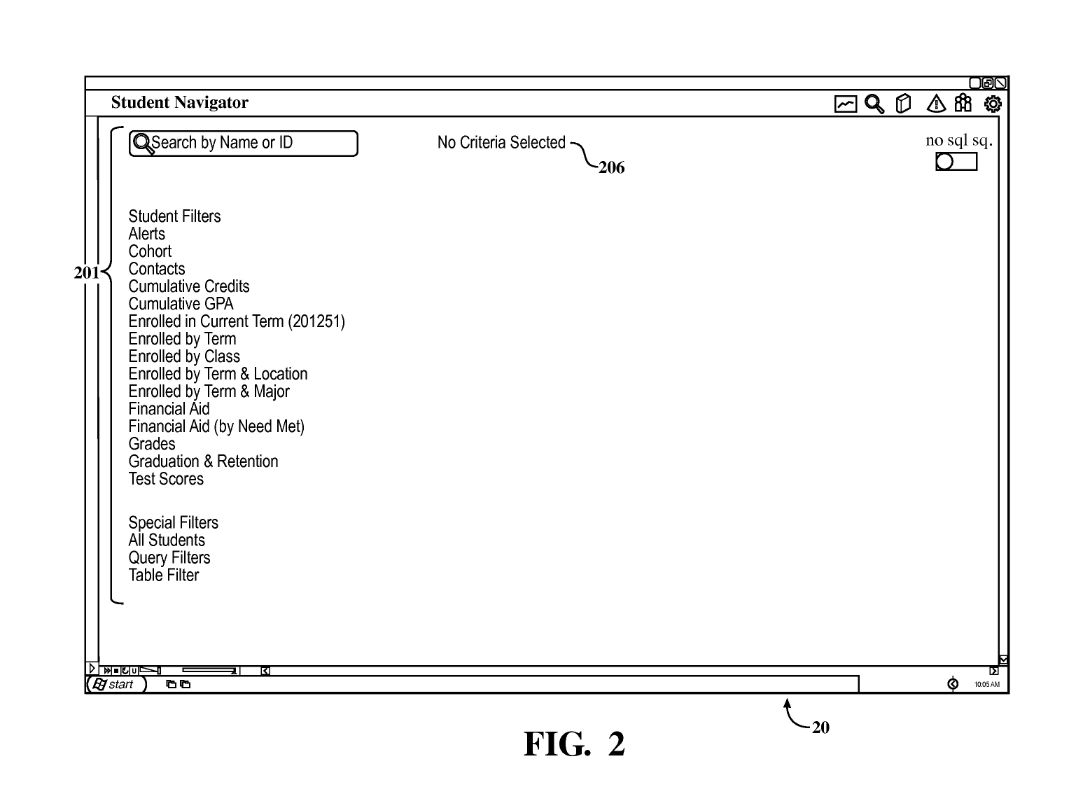

FIG. 2 shows a possible embodiment user interface 20 for a user's initial visit to the system. In this embodiment, upon initial visit, there are no filters active. FIG. 2 depicts filters field 201, which corresponds to field 101 of FIG. 1. However, fields corresponding to fields 102-105 of FIG. 1 are not shown in FIG. 2. Instead, FIG. 2 depicts field 206, which contains messaging for communicating that no filters have been selected in field 201. In this particular embodiment, a message is presented to the user “No criteria selected.” However, in other embodiments, active filter field may be empty, not displayed or various other messages indicating status are possible. As the user selects filters from the set of available filters in field 201, fields similar to those in FIG. 1, including but not limited to, fields 102-105 may appear. In this particular embodiment, where no filters are active, fields 103, 104 and 105 are not displayed. However, in various other embodiments one or more of these fields may be displayed where no filters are active. One or more of fields 103, 104 and/or 105 may by displayed as empty and/or include various messages indicating status, in various embodiments.

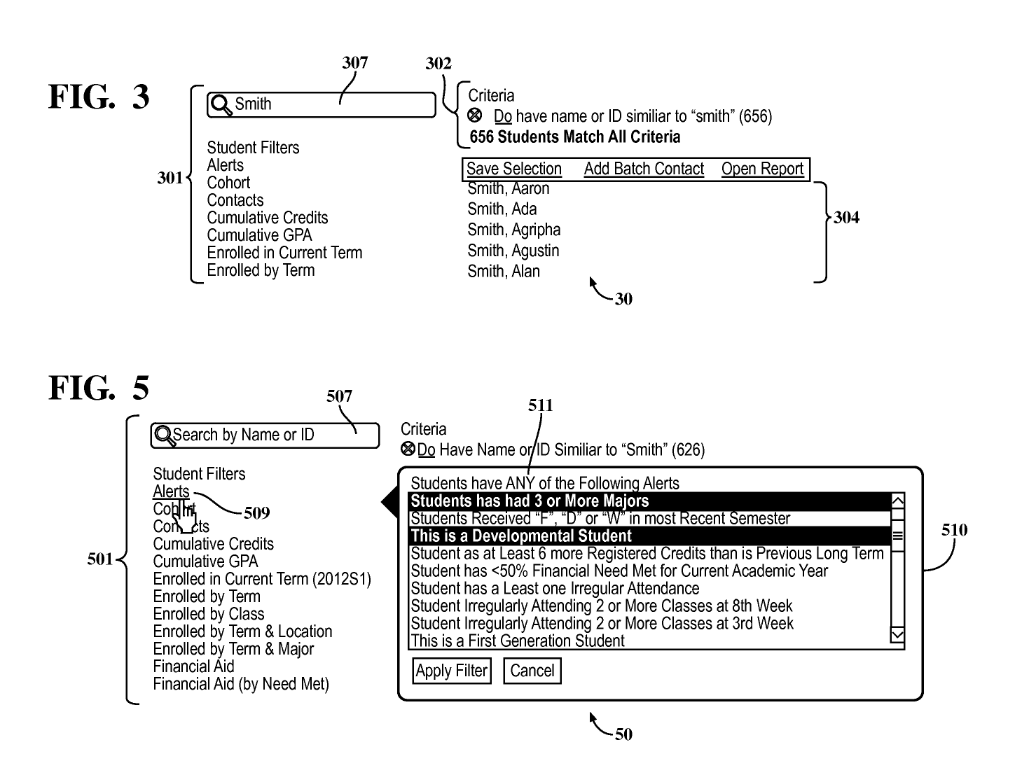

With reference to FIG. 3, in order to work with filters in field 301 (which corresponds to filter field 101 in FIG. 1), a user starts by selecting one of the available filters. Various manners, methods and means known in the art for a user to communicate selection of one or more items displayed on a user interface are possible within the scope and spirit of this application. One such filter is search box 307 that may allow a user to type alphanumeric characters to be used in searching a database of items. In this particular example, for a student database, a user may select a single student by his or her student ID or by first or last name by alphanumeric typing in search box 307. If a name is entered, it is possible that this may trigger the selection of many students. In the example of FIG. 3, the name “SMITH” returns multiple hits in query hits field 304 for names and/or student identification numbers similar to “SMITH.” Active filters field 302 shows that the name “SMITH” is the selected filter and that the system queries the database for hits “similar to” the criteria. Other embodiments could require an exact match in the filter criteria and hit, but this particular embodiment allows for hits that are similar to the filter criteria. The “similar to” functionality may be useful for misspellings and/or typographical error situations. Query hits field 304 shows the listing of hits from the database meeting the criteria name is “SMITH.” As shown in active filters field 302, there are 656 query hits meeting the criteria in this particular example. Claimed subject matter is not intended to be limited to this particular example, but broadly may extend to various database applications.

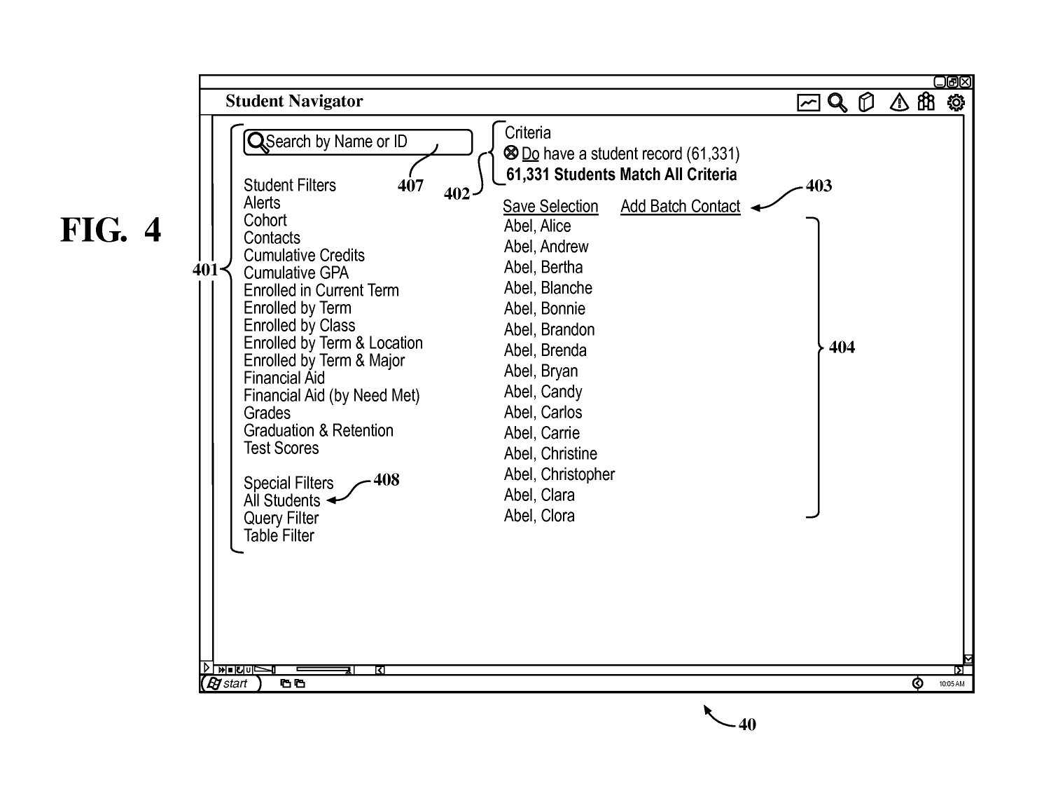

The database contains at any time information on a finite number of entries, which in this particular example are students. FIG. 4 displays a possible embodiment for displaying all data hits. To find out how many students are in the database or data warehouse at any point, the user can select an “All Students” filter 408 (shown in this particular embodiment in filters field 401). All Students filter 408 may be placed in various positions on user interface 40 in various embodiments. In this particular example using students as data entries in the database, All Students filter 408 displays the universal set of the data. In this particular example, there are 61,331 student entries in the database, as shown in active filter field 402. Field 403 includes actions that may be taken with the query, which in this particular example includes “Save Selection” and “Add Batch Content.” Query hit field 404 contains a listing of each database entry upon applying this filter.

FIG. 5 shows an example of a filter that opens a pop-up box or window upon selection. Filter field 501 shows that the “Alerts” filter 509 has been selected. This caused alerts pop-up box 510 to appear. Alerts pop-up box 510 contains functionality for communicating information about alerts. In this particular example, it may allow a user to communicate further information to narrow the query by type of “Alert.” By default in this particular embodiment, hits are listed where “ANY” of the “Alerts” are met, as shown with “ANY” link 511. A series of different alerts are listed in alerts pop-up box 510, which may be used to narrow search results. For example, “Alerts” may include, “Student has at least 6 more registered credits than previous long term;” “Student has <50% financial need met for current academic year;” and “Student has at least one irregular attendance.” Other “Alerts” are possible, and claimed subject matter is not intended to be limited to the particular alert examples shown in FIG. 5. Rather, other filters in field 501 may be part of various embodiments, which may produce one or more pop-up boxes 510 containing functionality for allowing a user to narrow hits in a search for “ALL” database items by adding one or more sub-filters to a filter selected in 501. For a search of “ANY” database items, pop-up boxes 510 may contain functionality for allowing a user to expand hits by employing one or more other filters. In this particular example, the sub-filter functionality is communicated via a pop-up box, but other manners of communicating sub-filter functionality are possible within the scope and spirit of this application. For example, sub-filters could appear in tree format in various embodiments. Claimed subject matter is not intended to be limited to the manner of displaying the sub-filter functionality.

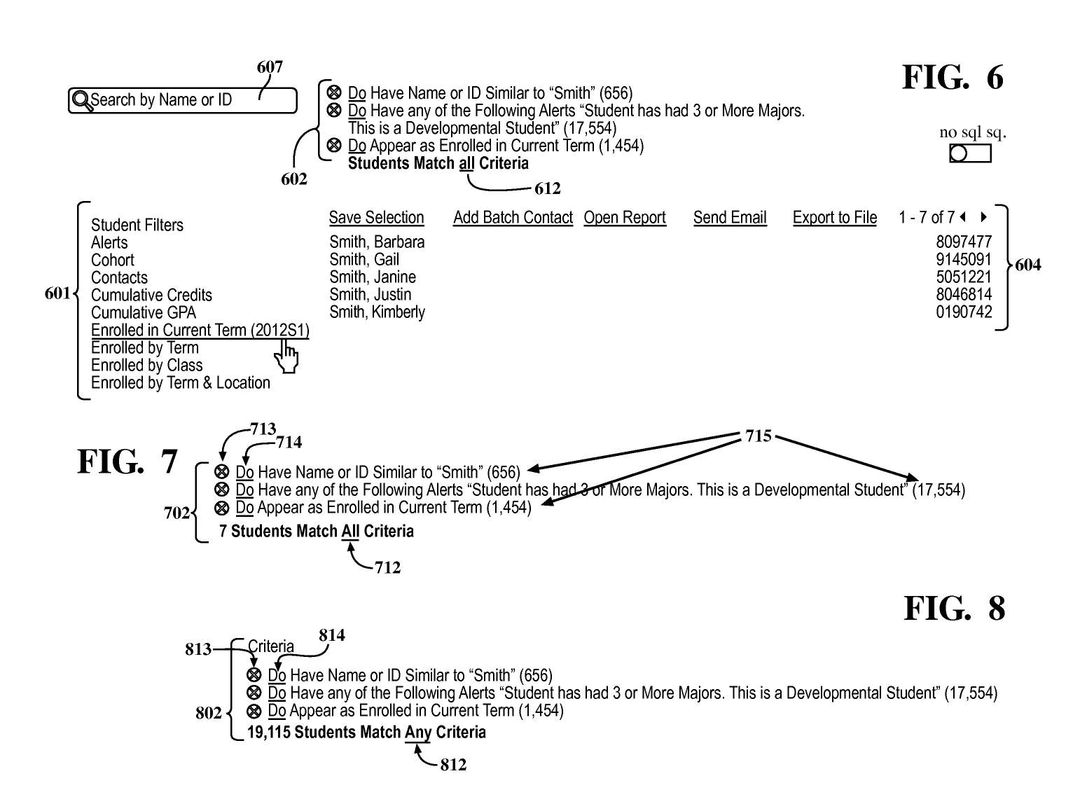

FIG. 6 depicts a parameters feature of the present application. One or more user interface embodiments may have one or more parameters which may be associated with one or more filters. The parameters may act to define a limit or boundary of the filter serving to limit query hits meeting criteria for the filter in a database search.

In various embodiments, parameters may include natural language terms such as but not limited to “ANY” and/or “ALL.” The user interface may provide one or more areas where the words “any” or “all” are shown as hyperlinks. All link 612 is an example of a toggle link, which may alternate between “ANY” and “ALL” based upon user selection. ANY link 511 described with respect to FIG. 5 may also function in this manner. The word “any” can be interpreted as a BOOLEAN “or”, or a set theory “union” by the system. However, the user need not understand the BOOLEAN or set theory logic behind the search in order to employ the more user-friendly terms to serve as search parameters. Similarly, the word “all” can be interpreted as a BOOLEAN “and” or a set theory “intersection”. For example, FIG. 5, can be interpreted as a selection of all the students who have either had three or more majors or are developmental students. In terms of sets, then the user may select the union of the set of students who have had three or more majors and the set of students who are developmental students.

Some filters do not require parameters. For example, the “Enrolled in current term . . . ” filter shown in field 601 displays a specific term. In this case, for this particular school, the 2012 Summer 1 term (2012S1) is in session. So, clicking this filter will immediately apply it. Field 602 shows this term added to the listing of applied criteria being used to filter database entries, and 612 shows that this particular query is searching for “ALL” database items that match this combination of filters. If one or more filters is active, the listing in field 602 of currently active filters becomes visible in the user interface. Field 604 displays the results for the query, showing database items meeting the criteria selected as shown in field 602. Similarly, search field 607 may accept search terms therein which do not require a parameter to define one or more boundaries for the typed in search term filter.

As shown in FIG. 7, for each active filter, there is a deactivation control 713. In this embodiment, the deactivation control is a circle with an “X” in it, which may be selected by a user. Other denotations for manners of communicating deactivation of a filter are possible within the scope and spirit of this application, and this is merely one possible example of embodying this functionality.

FIG. 7 also shows a negation control 714 for each active filter. In one or more embodiments, one or more filters may have a negation control 714, such as but not limited to, a negation control 714 in the form of a toggle switch (shown in FIG. 7 as a hyperlink that changes between “Do” and “Don't” when clicked). Various other negation controls 714 are possible within the scope and spirit of this application. The label “Don't” can be interpreted as a BOOLEAN “not” or a set theory “complement”. Other labels may be used to employ this functionality. This allows users to quickly select students who do not comply with some criteria, by first selecting the given criteria using the corresponding filter and then clicking on the negation control 714. The sum of the cardinality shown by an active filter with “Do” and the cardinality shown by the same filter with “Don't” equals the cardinality of the “All Students” set (the universal set) because one is the complement of the other. By use of the simple “Do” and “Don't” language, users may apply search filters without requiring an understanding of the BOOLEAN or set theory logic behind the search. Other language may be used with other embodiments of negation filters 714. Claimed subject matter is not intended to be limited to this particular filter embodiment.

In this embodiment, there also is an “ANY” and “ALL” filter 712. In FIG. 7, it is shown at the bottom of the active filters area 702. It may be located in various positions in various user interface embodiments. “ANY” and “ALL” filter 712 may act as a toggle switch in this particular embodiment which determines how the sets of students produced by the individual active filters are combined to yield the set of selected students. The word “all” may be interpreted as a BOOLEAN “and” or a set theory “intersection”. The word “any” may be interpreted as a BOOLEAN “or” or a set theory “union”. In the case shown in FIG. 7, the seven selected students are all the students who have a name similar to “smith” and who also have either had three or more majors or are developmental students and who also are enrolled in the current term. As a rule, when the word “all” appears, then the number to the left of that line (7 in this case) will be less than or equal to each of the cardinalities 715 listed for the individual filters because the result is the intersection of those sets. As a rule, when the word “any” appears, then the number at the left of that line will be greater than or equal to each of the cardinalities 715 listed for the individual filters because the result is the union of those sets. By use of the simple “ALL” and “ANY” language, users may apply search filters without requiring an understanding of the BOOLEAN or set theory logic behind the search. Other language may be used with other embodiments of filters 712. Claimed subject matter is not intended to be limited to this particular filter embodiment.

FIG. 8 focuses on active filter field 802. It shows an example of the “any” and “all” filter 812 being set to “ANY”. In set theory, it shows the result of the union of sets produced by each active filter. The cardinality of this particular sample case is 19,116 students meeting “any” of the set criteria. Deactivations controls 813 and negation controls 814 correspond to deactivation controls 713 and negation controls 714 described above with reference to FIG. 7.

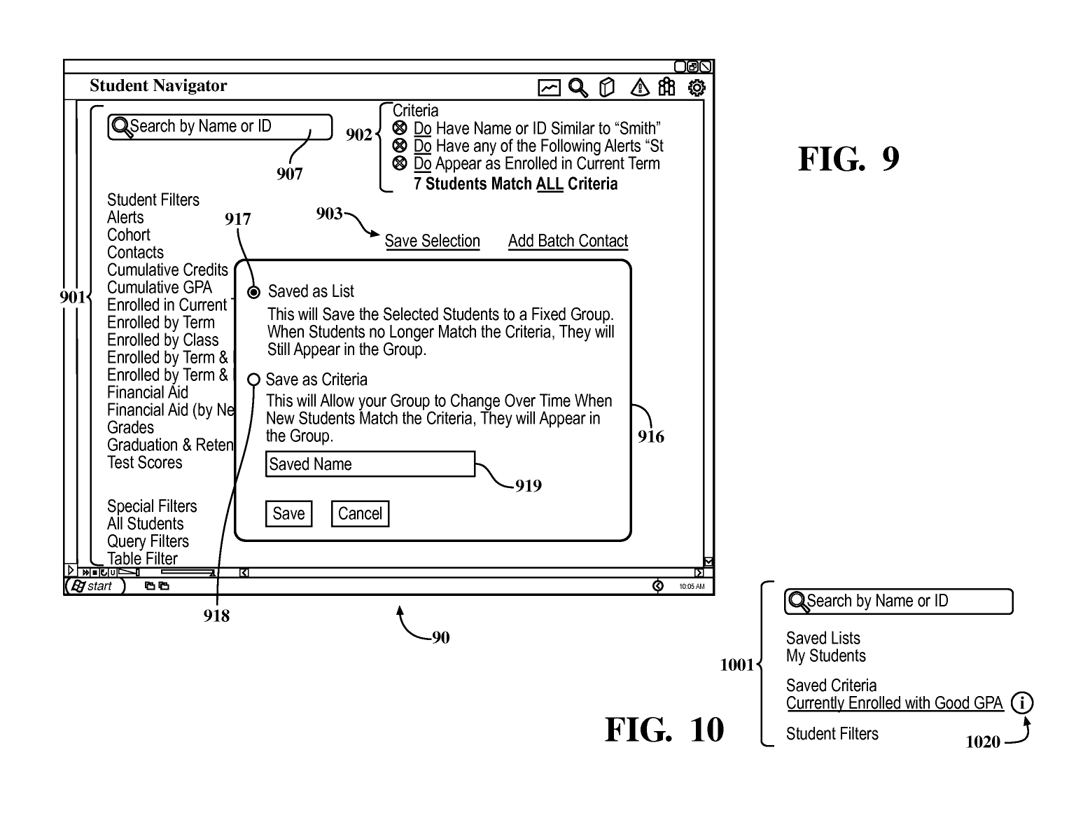

One or more embodiments may be capable of saving searches. As shown in user interface 90 of FIG. 9, searches may be saved into a new filter by selecting Save Selection from field 903. This may open a pop-up box 916 to communicate further information regarding save options of the system. In this particular example, save options include Save as List 917 or Save as Criteria 918 and naming the filter at Saved Name 919. Searches may be saved by a list of the results. By selecting “Save as List” 917, the system is capable of saving the list of results as a stagnant list. The list would not change if hits, such as students, fell outside of the searching criteria. They would still appear in the group. Similarly, new hits meeting the search parameters and criteria would not be later added to the list of results. In this particular example, a listing of 7 students would be statically saved. Searches may also be saved as criteria by selecting Save as Criteria 918. This functionality allows the system to save the criteria and parameters, rather than the fixed list of hits, which would result in a dynamic set of results which could change when accessed to reflect the list of hits meeting the saved criteria and parameters at one or more later accesses to the saved search. If one or more new hits match the saved criteria and/or parameters, the new hit would be added to the results list. If one or more hits no longer met the saved criteria and/or parameters, that hit would be removed from the results list at the time the filter runs. In one or more embodiments, a user may name the saved search at Saved Name 919. Claimed subject matter is not intended to be limited to this optional feature that may be available with some embodiments.

In various embodiments, as shown in FIG. 10, if one or more lists are saved, the saved lists may appear in field 1001 (which corresponds to field 101 in FIG. 1), as an option for a user to select. Saved lists may be displayed in various positions on the user interface in various embodiments. In this particular example, a saved search is named “Currently Enrolled with Good GPA.” In this particular embodiment, if a user hovers over or otherwise selects a saved list of a saved criteria filter, an information icon 1020 may appear to the right of the filter. This is merely one possible embodiment for this functionality, and many more are possible within the scope and spirit of this application. Claimed subject matter is not intended to be limited to this particular optional feature.

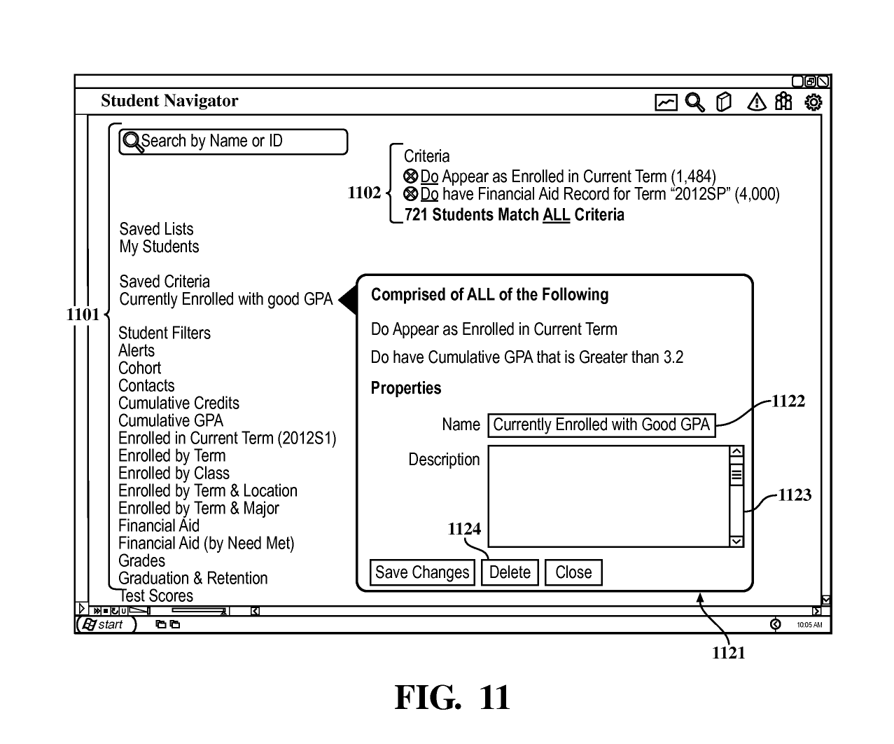

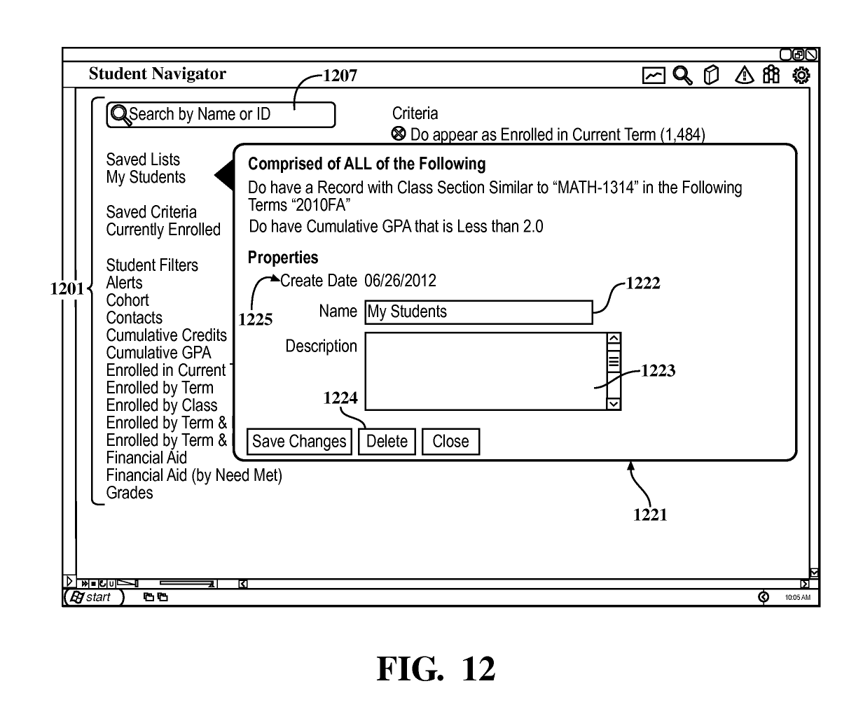

If a user clicks or otherwise selects information icon 1020, the system may display information regarding the saved filter, as shown in FIG. 11. In this particular example, the information is displayed in a pop-up box or window 1121 (shown to the right of field 1101 in this particular example), which includes a listing of the search criteria and/or parameters for the saved search. In various embodiments, there may be functionality capable of modifying the saved criteria shown in box 1121, such as to edit the name of the search in name field 1122 and/or edit a description of the search in description field 1123. There may be functionality in window 1121 to delete the saved filter, such as delete button 1124. As shown in FIG. 12, for a saved list filter (in this particular example entitled “My Students,” as shown in field 1201 below search field 1207), window 1221 also includes date information for when the filter was created at create date 1225 (here “Jun. 26, 2012”) which may be useful since the list of hits is a stagnant list measured at a particular point in time for this type of saved search. Saved list filter pop-up box also includes name field 1222, description field 1223 and delete button 1224, which function as described with reference to FIG. 11. Of course, claimed subject matter is not intended to be limited to this particular placement of the functional elements on the user interface display, and many other displays showing system functionality are possible within the scope and spirit of the application.

Once saved, the saved search may act as a filter. It may be used like any other filter. It may be activated, negated, and/or combined with other filters. In this manner, one or more embodiments are capable of creating customized filters. Saved filters may be used to implement parenthesis, which may add in a hierarchy to the searching, as described in mathematical terms. For example, if a user creates a complex expression of filters such as “(a and not b) or c”, or in terms of sets “(a intersection b's complement) union c” where a, b, and c are arbitrary filters, this expression may be evaluated as follows: (1) activate filters a and b; (2) negate filter b (click on “Do”); (3) make sure the filters are combined with “all”; (4) save the resulting filter (say as filter d); (5) activate filters d and a; and (6) make sure that they are combined with “any”. In one or more embodiments, saving a search may not be needed and the present system may facilitate use of parentheses and/or parenthetical mathematic equations, such as but not limited to, by indenting. Finally, because the “and” and “or” BOOLEAN operators, as well as the “union” and “intersection” set operators, are commutative, the order in which filters are activated has no bearing on the resulting set of selected students. This is merely one possible example, and claimed subject matter is not intended to be limited to this particular embodiment.

Various embodiments may optionally include table filter functionality. A table filter is a more advanced filter that allows a user to define how to select database items, such as students in this particular example, based on the contents of a table or cube in the data warehouse. The information in the database or data warehouse may be maintained as a set of OLAP cubes. Each cube may contain a set of measures and/or dimensions. Each cube may also be represented as a set of de-normalized tables in a star or snowflake schema design in a relational database. Other complex database structures are possible. Regardless of internal representation, the user sees in the table filters what appears as a set of tables to select from. In this manner, the system provides a simplified user interface for users to use to manipulate data and/or allowing a user to create and/or save a filter that represents a more complex SQL criteria, for database searches, without requiring the user to understand complex database structures. For example, the table filter on the class column may be used to identify all students who have ever taken a certain class (such as but not limited to, college level algebra), and then save that filter as “Students who have ever taken College Level Algebra,” which may then be combined with one or more other filters. Claimed subject matter is not intended to be limited to this particular example.

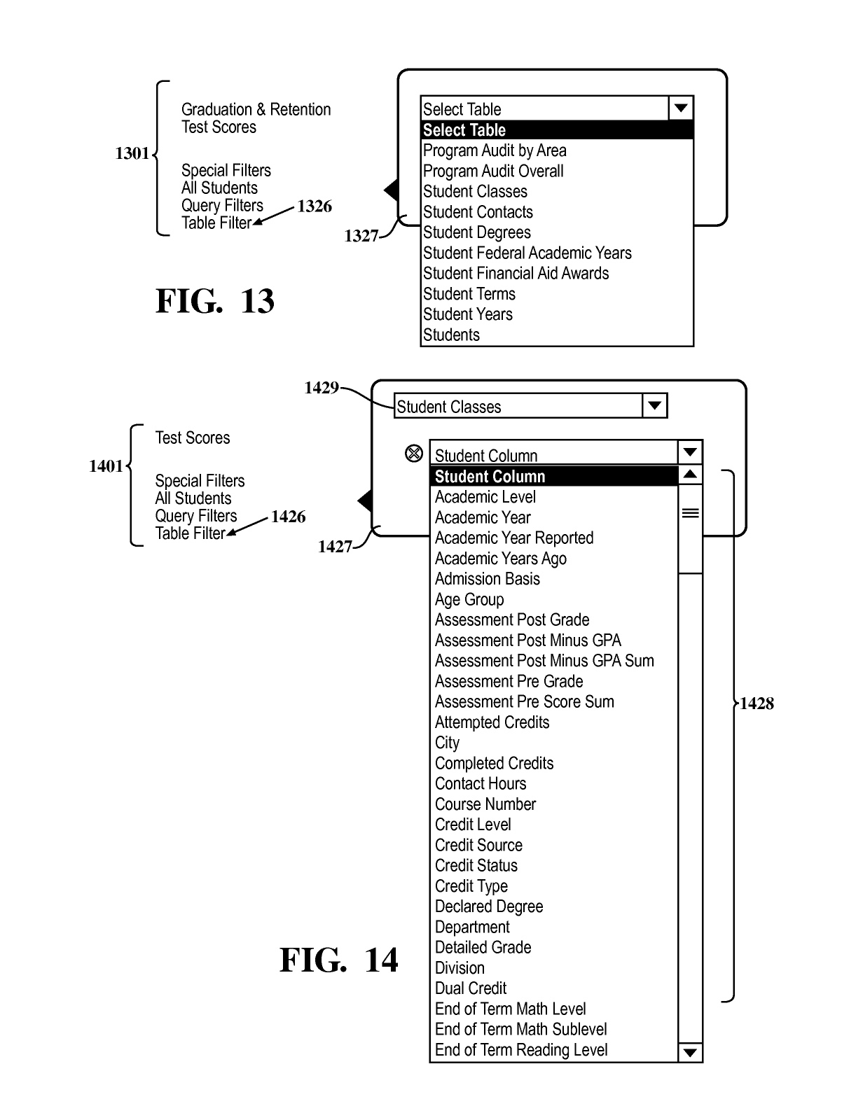

As shown in FIG. 13, “Table Filter” 1326 may be selected from field 1301. In this particular embodiment, selecting table filter 1326 results in a pop-up window 1327, containing a pull down menu. Various means, methods and manners of displaying data on a user interface are possible within the scope and spirit of this application, and claimed subject matter is not intended to be limited to the particular manner of this particular embodiment. In this example, “Select Table” may be highlighted or otherwise selected. In various embodiments, there may be a listing of tables provided by the system for the user to select and/or functionality allowing a user to create a customized table. Once a table is selected, each table appears to have a set of columns (measures and dimensions). For example, for the following tables the given columns might be available. For the example table labeled “Students” shown in box 1327, the example table may contain one record per student. The dimensions may be columns like ethnicity, gender, active major, etc. The measures may be columns like cumulative GPA, completed credits, etc. By way of a second example, example table “Student Classes” may contain one record per class taken by each student at this college over time. The dimensions at this level may be columns like subject taken, course number taken, term when the class was taken, final grade for that student in that class, department offering the class, etc. The measures may be columns like completed credits for that student in that class, GPA for that student in that class, etc. Many other types of tables, table structure and content are possible within the scope and spirit of this application.

The difference between a measure and a dimension in this particular embodiment is that measures are numbers that can be added or averaged, for example, to obtain cumulative metrics; whereas dimensions are normally categorical. In the table filter we refer to dimensions or measures generically as columns. At this level, the user will only see a difference, in that depending on the nature of the column, the filtering criteria may differ. For columns that are measures, it makes sense to ask for ranges (for example, select students with GPA <2.0); whereas for dimensions, it makes sense to enumerate a set of desired values (for example, select students with ethnicity “White” or “Asian”). This functionality may go deeper than just the distinction between measures and dimensions. Some dimensions are dates (such as a student's birthdate). For dates it makes sense to ask for a range of desired dates (for example, select students who were born between Jan. 1, 1990 and Dec. 31, 1995). The table filters are designed to be sensitive to the type of column used.

In this particular example, as shown in FIG. 14, if a user selects “Student Classes” for a table (shown in FIG. 13), the columns for that table become available for the Student Classes filter, shown in box 1427, which may be displayed as a second pull down menu 1428, or by various other manners. “Student Classes” is shown in field 1429, and “Table Filter” 1426 is shown in field 1401. Pull down menu 1428 shows the available pre-set columns available to be used with the “Student Classes” filter in this particular example. Various embodiments may include pre-set columns for a user to select and/or functionality allowing a user to create customized columns. Claimed subject matter is not intended to be limited to this particular embodiment.

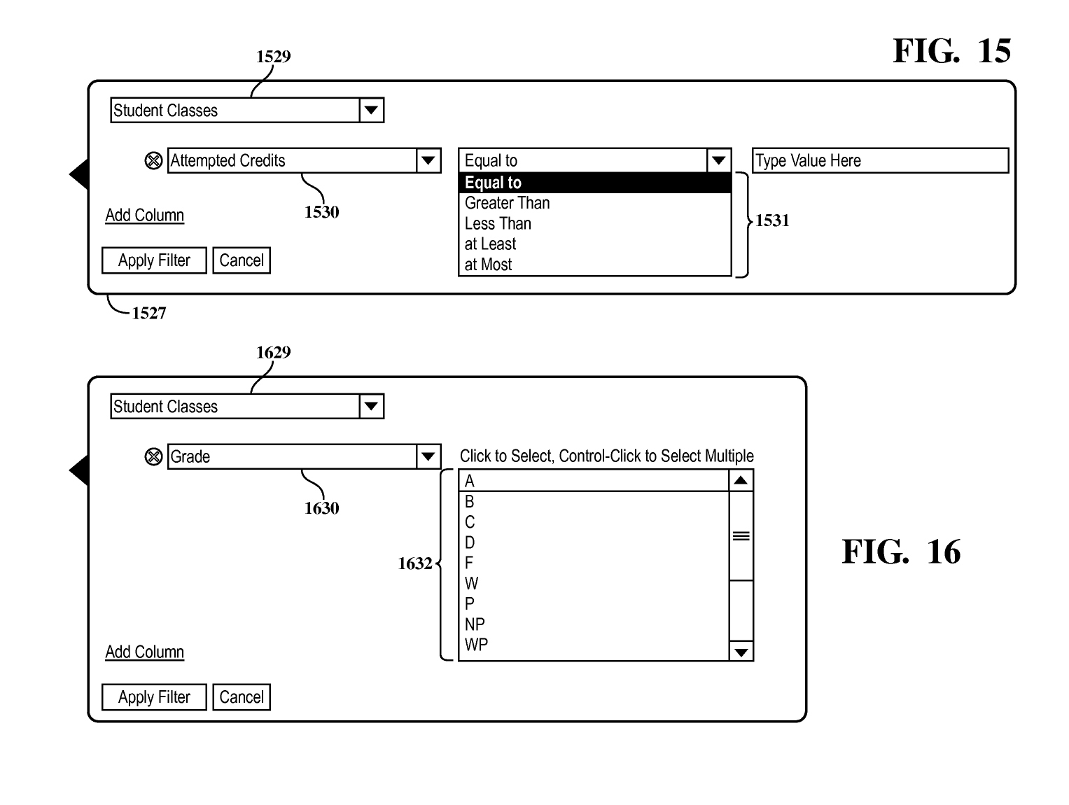

FIG. 15 shows an example of how comparisons may be allowed for numeric fields in a table filter. In this particular example, in pop-up box 1527, “Attempted credits” has been selected from pull down menu 1428 shown in FIG. 14, as a column to modify “Student Classes” shown in field 1529. “Attempted Credits” is displayed in field 1530. This has opened up pull down menu 1531, and the system allows a user to select “equal to”, “greater than”, “less than”, “at least” or “at most” as parameters or relational operators to define one or more boundaries of the “Attempted Credit” criteria employed. One or more embodiments may also allow a user to type a particular numeric value to be used as the parameter. This functionality may appear in a pop-up box, window or otherwise to a user in various embodiments. One or more embodiments may allow a user to add a column, such as by clicking on a hyperlink to access this functionality. These are merely examples of possible embodiments, and this optional functionality is not intended to limit claimed subject matter.

FIG. 16 shows an example of categorical parameter functionality. Categorical parameter functionality may serve to limit search criteria, such as but not limited to, column criteria in a table. In this example, “Grade” has been selected as criteria, as shown in field 1630. A pull down menu 1632 of set values that may define the “Grade” column criteria has appeared to the user. One or more parameters may be selected to serve as search criteria for the categorical parameters. Grade 1630 is a column selected in this particular example, and as shown in field 1629 “Student Classes” has also been selected as a table. Various embodiments may also contain functionality allowing a user to customize parameters available for categorical parameter functionality. Claimed subject matter is not intended to be limited to this particular example.

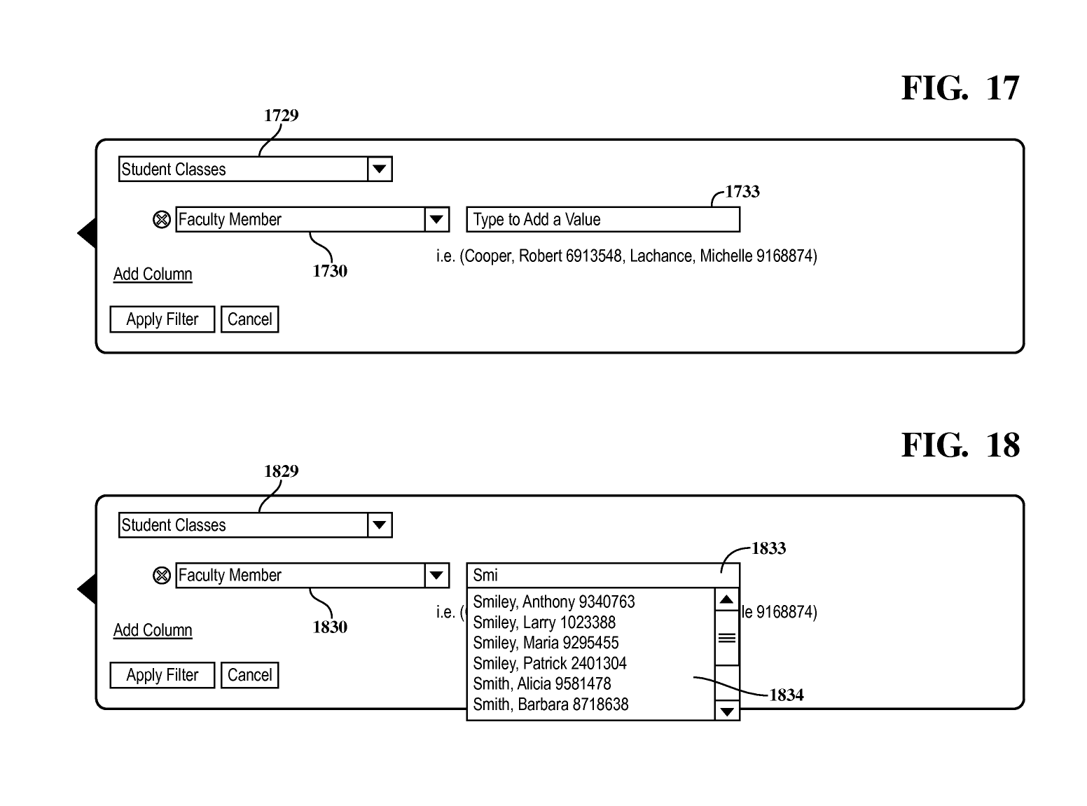

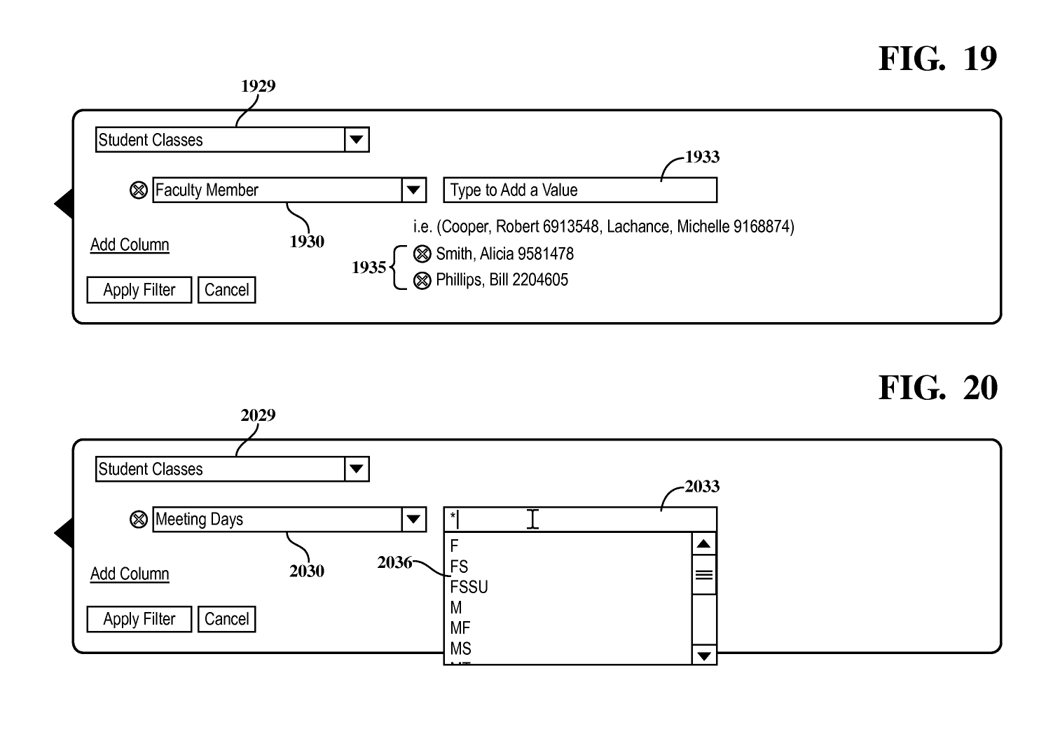

In some embodiments, where a pull down menu of criteria and/or parameters contains more than one result, such as but not limited to, instances where there may exist too many results to display at one time to a user, the system may contain functionality allowing a user to type in a parameter to alphanumerically narrow the listing available, such as but not limited to, that displayed in a pull down menu. As shown in FIG. 17, for the column “Faculty Member” that is displayed in field 1730, a user may type in field 1733 to receive a list of faculty members meeting the typed characters. Some embodiments may have functionality for displaying parameters similar to, not requiring exact matches, for parameters called by the typed characters. For each keystroke adding in typed criteria, a listing of faculty members matching the criteria appears in a pull down menu 1834 from field 1833, as shown in FIG. 18. A user may select one or more parameters from the pull down menu 1834 to apply to the column, to act as a criteria defining the “Faculty Member” filter of field 1830, as shown in FIG. 19 as selections 1935.

The system may contain control functionality for one or more selections in selections field 1935, such as but not limited to, negation functionality to be used with the parameters, as described above. For this particular example, type-recognized parameters may include hits matching last name, first name and/or faculty employee number. Many other type-recognized parameters are possible, and claimed subject matter is not so limited. Claimed subject matter is not intended to be limited by this optional typed feature nor by the particular user interface implementation of this functionality.

Some embodiments may contain functionality for displaying the entire listing of criteria and/or parameters available. For example, FIG. 20 shows that column parameter “Meeting Days” has been selected, as displayed in field 2030. Scroll down menu 2036 appears in association with the criteria selected in field 2030. Some embodiments may allow a user to type an asterisks or other character in field 2033 to call the universal set of available parameters in scrolling pull down menu 2036. Scrolling pull down menu 2036 is merely but one manner of displaying results, and many other user interface implementations for this functionality are possible within the scope and spirit of this application.

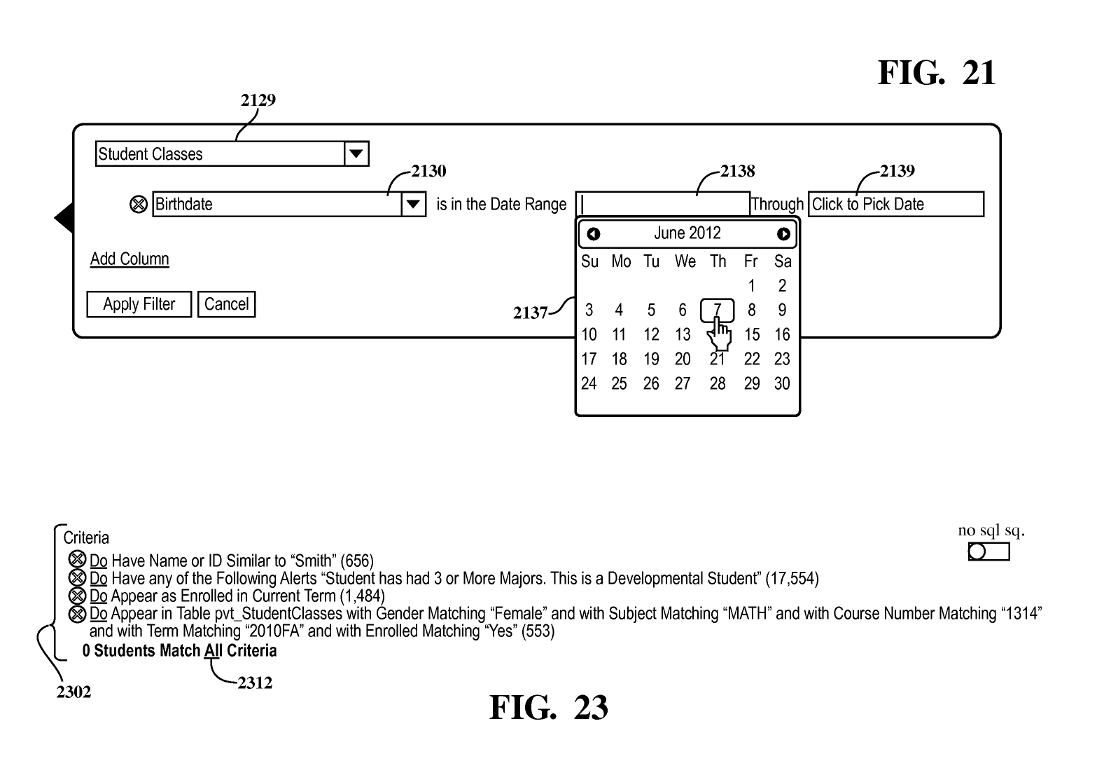

FIG. 21 shows an example column “Birthdate” that calls a pop-up calendar feature 2137, which allows a user to select a date or date range to modify the column criteria. Alternately, a user may type date information into fields 2138 and/or 2139 to limit the date range. Claimed subject matter is not intended to be limited to this optional feature.

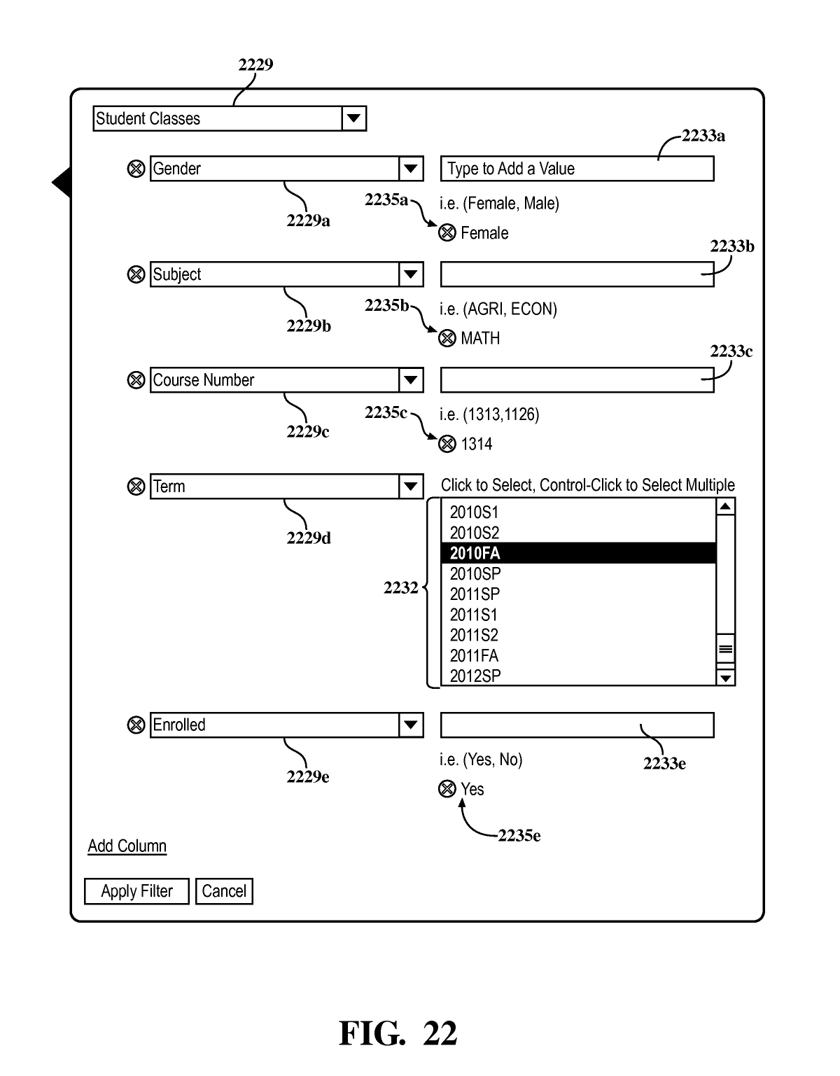

FIG. 22 is an example of a complex table filter. FIG. 22 shows “Student Classes” selected for the table, as displayed in field 2229. It has been narrowed with further applied criteria, as shown in fields 2229a-e. In field 2229a, “Gender” has been selected. There is a typing field 2233a that allows a user to type alphanumeric text to add further gender criteria. Selection “Female” appears in selections field 2235a with a deactivation control. The deactivation control may be used to remove the criteria from the filter. In field 2229b, “Subject” has been selected. There is a typing field 2233b that accepts alphanumeric text therein for further qualifying this filter. “MATH” has been selected, as shown in selections field 2235b. In field 2229c, “Course Number” has been selected. There is a typing field 2233c that allows a user to type alphanumeric text to add further sub-filter criteria. Selection “1314” appears in selections field 2235c with a deactivation control. In field 2229d, “Term” has been selected. Pull down menu 2232 contains set choices from which a user may select sub-filter criteria. Field 2229e contains “Enrolled” as a selected filter. There is a typing field 2233e that allows a user to type alphanumeric text to add further sub-filter criteria. Selection “Yes” appears in selections field 2235e with a deactivation control. This is merely one example of a table filter built using the user interface and system of the present application, and many more examples are possible within the scope and spirit of this application.

When multiple columns are specified in a table filter, only hits, such as students in this example, that have at least one record that complies with all the specified conditions are selected, as shown in FIG. 23. In this particular example, all switch 2312 is selected, and no students matched “all” the criteria selected with the table filter. Claimed subject matter is not limited to this particular example.

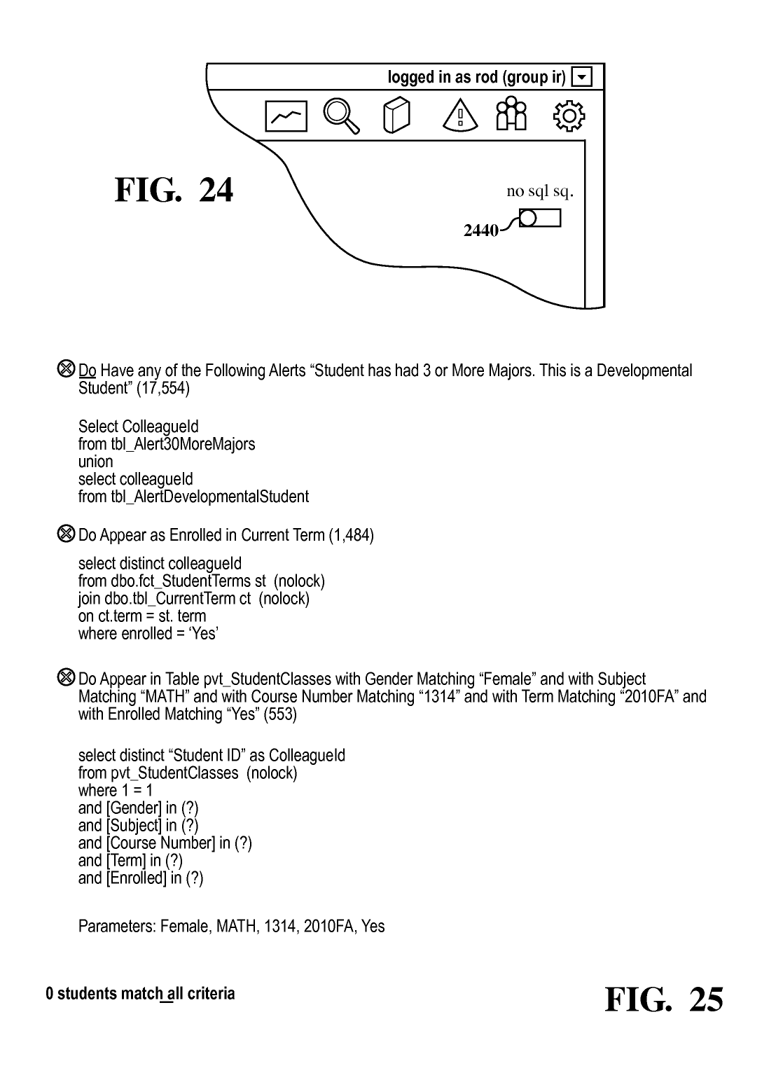

In one or more embodiments, the system may include a user interface element for displaying SQL statements used to implement the filters. Such an example is shown in FIG. 24. A toggle switch 2440 is shown in FIG. 24 for implementing this functionality. Once displayed, the SQL statements may be viewed, copied, pasted or otherwise used by a user as a basis to create one or more query filters. However, various other user interface embodiments are possible within the scope and spirit of this application for implementing this functionality.

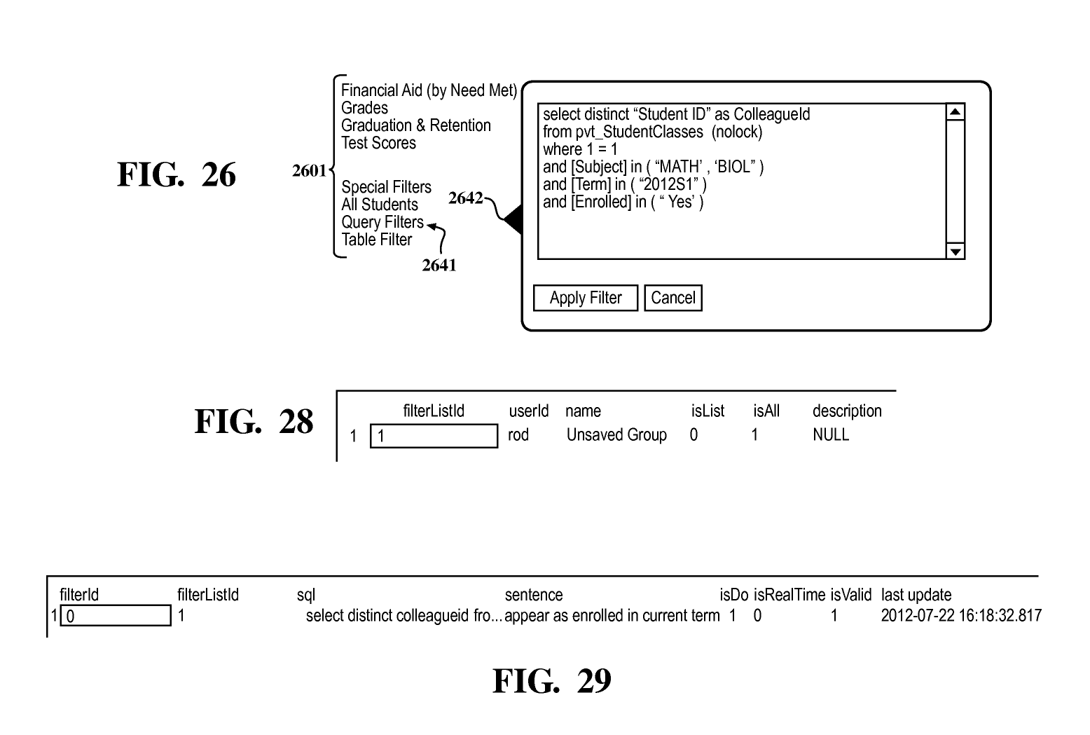

FIG. 25 shows the SQL statements generated by the filters selected, as shown in FIG. 23, for this particular example. The SQL query functionality may allow a user to type in SQL statements in addition to and/or instead of selecting filters. For example, should a user wish to select all students who took MATH or BIOL classes in 2012S1 regardless of gender, this may be done with a table filter, but it also may be accomplished using the SQL language with the query filter. For example, the SQL generated by the table filter may be copied (defined in the last example) and transformed to use the query filter. As shown in FIG. 26, by selecting the query filter 2641, a SQL text box 2642 opens up on the user interface into which a user may type SQL queries to create one or more filters. SQL text box 2642 may include functionality for saving, naming, and/or applying the SQL language as a new filter. Claimed subject matter is not intended to be limited to this particular optional feature of some embodiments.

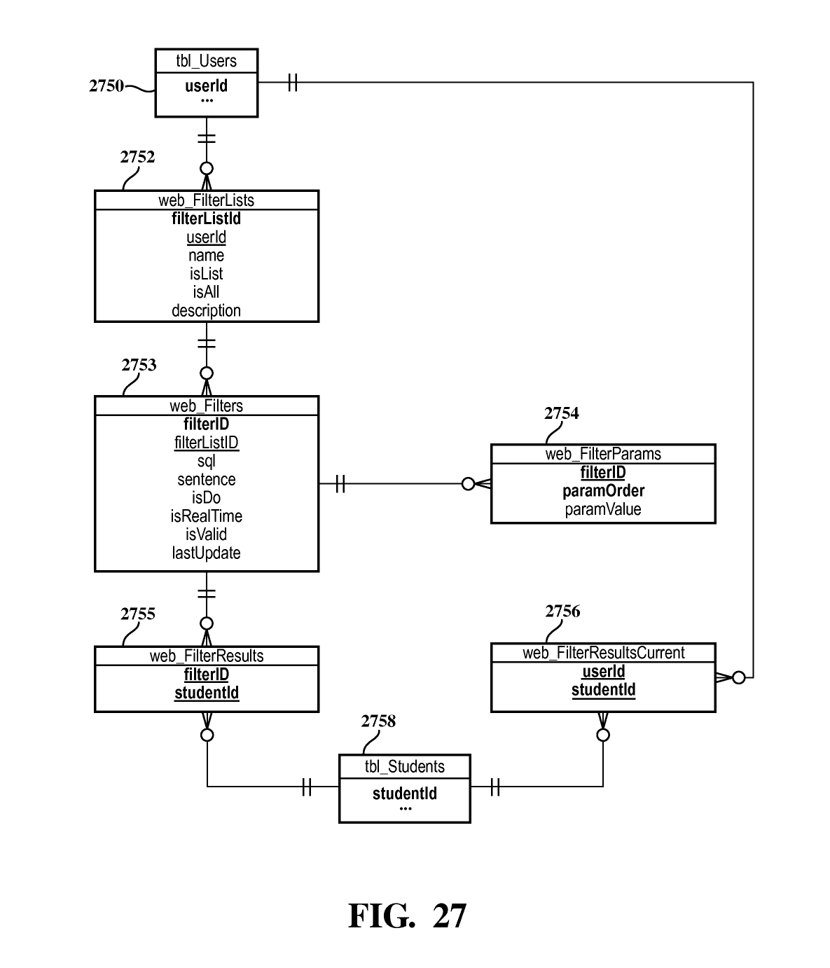

One or more embodiments of the system may be implemented on a relational database. In one or more embodiments, the filters themselves may not be represented in the database, but may be described in the code only. In one or more embodiments, the database may contain one or more sets of active filters (which may be identified separately for each user). With reference to FIG. 27, in some embodiments, there may be a table identifying system users, such as tbl_Users 2750. It may contain a listing of user identification numbers or other user identifying information. In one or more embodiments, this table may have one row per user of the system, such as for the student navigator example. The user's attributes are not necessarily relevant to the system, apart from that each user is identified with a “userId” in this particular example. In one or more embodiments, apart from adding in user identifying information, this table is not modified by the system.

In some embodiments, a single set of active filters may be identified for each user. For example, in one embodiment this may be contained in one row in a table labeled web_FilterLists 2752 having as many rows as it has filters in web_Filters 2753. In one or more embodiments, the database may contain one or more saved filters (either as list or as criteria). For example, this may be contained in one row in web_FilterLists 2752 and as many rows as the saved filter had component filters in web_Filters 2753. In one or more embodiments, the database may include each filter (whether active or saved) with a corresponding SQL SELECT statement stored in its web_Filters 2753 row. For one or more such statements, there may be many rows in web_FilterParams 2754, each representing one parameter required by the SELECT statement (parameters may be indicated with “?” characters in the SQL statement). In one or more embodiments, the database may contain hits identified by one or more filters (whether active or saved) which selects zero or more students. For example, for one or more of each filter, the selected students may be saved in the web_FilterResults table 2755. In some embodiments, the database may contain hits identified by one or more of each set of active filters which selects zero or more students. For example, they may be found by looking into the web_FilterResults table 2755 and combined into the web_FilterResultsCurrent table 2756. One or more embodiments may also contain a table tbl_Students 2758 listing all database hit entries, which in this example are students. This table may have one row per student, as in this particular example. The student's attributes may not be relevant to the system, apart from that each student is identified with a “studentId” in this particular example. Student attributes may include information that is used by one or more filters for identifying student hits during queries. In some embodiments, this table may not be modified by the system. In various embodiments, it may be a look-up table of input data entries that the system accesses for tasks including searches. Although the current description is focused on students as the objects of interests to the navigator, the schema described here and all the concepts, data structures, object-oriented design, and algorithms would apply to many other applications and domains. For example, a faculty navigator or a class section navigator could be written using the schemas, data structures, object-oriented designs, and/or algorithms as those described herein. Many other non-education related applications are possible, such as but not limited to, entity databases, employee databases, product databases, inventory databases, vendor or supplier databases, customer databases, materials databases, scheduling databases, and many other database applications.

As shown in FIG. 27, in this particular embodiment, the names of the columns of web_FilterLists table 2752 include: filterListId, userID, name, is List, is All and description, in this particular example. In this particular example, the column name in bold, filterListId, represents the primary key for this table. In this particular example, the underlined name, userId, is a foreign key that points to one or more other tables. In FIG. 27, a column name that is bold and underlined is a column that is part of the primary key and is also a foreign key. The lines connecting tables are used to denote the connection from one table with a foreign key to the table where that column is the primary key (the chicken feet are on the side of the foreign key). For tables of FIG. 27, the columns are listed in the box below the table name, using the above-described denotations for primary and foreign keys. However, many other designations are possible, and this is but one possible embodiment and implementation of subject matter described herein.

Web_FilterLists table 2752 of this particular example may have one row per filter list that is either active or stored. A filter list may be used in at least two contexts. First, it may be used for an active filter list. If a user activates filters, the filters that appear in the set of active filters (see FIG. 1, active filters field 102) may be represented in the database as a row in this table. This is a row that has the reserved name “Unsaved Group” in this particular example, although any other name or no name may be employed and claimed subject matter is not so limited. Second, web_FilterLists table 2752 may be used for a saved filter list. If a user saves a filter, the row that represents the set of active filters may be modified, such as but not limited to, as follows: (a) the name may change from “Unsaved Group” to the user assigned name; and/or (b) the is List column may change to True if the user saves the filter as a list instead of as criteria. A new row may be added to keep track of the currently selected set of active filters (which has the reserved name “Unsaved Group” in this particular embodiment). One or more rows with the value “Unsaved Group” in the name column represent the set of active filters for each user. Each user may have one row with this name in this particular embodiment. Other rows may correspond to saved lists of filters. The user generally does not save a single filter, but rather a user generally saves a set of (active) filters. However, the set can be made up of a single filter. One or more saved filter lists may appear either under “Saved Lists” when their is List column is True or under “Saved Criteria” when the is List column is False.

One or more filter lists may have a description which may be stored in the description field. One or more filter lists may have one or more any/all toggle switches associated thereto. The state of this switch may be stored in the is All field. One or more of each row in all the other web_. . . tables (web_Filters 2753, web_FilterParams 2754, web_FilterResults 2755, and/or web_FilterResultsCurrent 2756) may be related to a single row in web_FilterLists 2752. This may be viewed by following the foreign key relationships in FIG. 27 and noting that each row in web_FilterResultsCurrent 2756 belongs to the single active filter list for the given userId.

In this particular embodiment, web_Filters 2753 has one row per filter that is either active or stored. A row may be created if a user clicks on (or otherwise selects) any of the available filters. This may include saved filters. For example, if the user clicks on the “Enrolled in current term” filter, a record in this table is created. The fields that may be initialized may include one or more columns of the table. For example, filterId may be initiated. This is an automatically incremented field that is given a distinct value by the database whenever a row is added. Another column, filterListId, is a foreign key to the “Unsaved Group” row in web_FilterLists 2752 for the userId performing the operation. There is a SQL SELECT statement, sql, that may run to retrieve one or more IDs of the students that are selected by this filter. The SELECT statement may return a list of studentIds. In this particular embodiment, the “sentence” column of web_Filters 2753 is the human-readable sentence that is placed as a label for the filter in the user interface. The “is Do” column is a BOOLEAN field that may reflect the state of the negation control (do/don't) for this filter. The “is RealTime” column is a BOOLEAN field that may be used to determine if the SQL SELECT statement needs to run. If all tables used by the SELECT statement are modified only overnight, then the filter is not real-time and can be recalculated once per night when the database or data warehouse is updated. Otherwise, the filter needs to run more frequently to maintain the list of selected students up-to-date. The “is Valid” column of this particular embodiment is a BOOLEAN field that may be used to invalidate a filter, such as if the schema ever changes to a point where the SELECT statement is no longer valid. Finally, the “lastUpdate” column of this particular embodiment is the time when the SELECT statement in the filter ran for the last time. Various other columns associated with web_Filters 2753 are possible in different embodiments, and claimed subject matter is not intended to be limited to this example.

As described above, some filters have parameters. In one embodiment, these may be stored in web_FilterParams table 2754. Filters that prompt for parameters in the user interface normally generate the SELECT statement as a fixed string and then specify the user-provided parameters one per row in this table. The SELECT statement has parameter markers, and the parameters in web_FilterParams table 2754 may be provided in the order specified by the paramOrder column (therein) to fully specify the query. This is merely one example of a possible architecture for a system in accordance with one or more embodiments described herein. Other syntax, architecture, schemas and structure are possible.

A web_FilterResults table 2755 may contain one or more rows that may each be associated with one row in web_Filters table 2753. For example, each row may represent a student that is selected by the filter in web_Filters table 2753. If a new filter is selected by a user, a row may be created in web_Filters table 2753. Then the SQL used to select students may run and return a list of studentIds (query hits in this example). For each distinct studentId returned, a row may be added in web_FilterResults table 2755 to represent the fact that the filter selected that student. Web_FilterResults table 2755 may be updated, as described below.

A web_FilterResultsCurrent table 2756 may contain one or more rows for one or more student query hits selected by the active list of filters. A system user may have one row in web_FilterLists table 2752 that represents the active list of filters. Other embodiments may allow for more than one row to represent active lists of filters. One or more of each of the filters in that list may have a list of selected students in web_FilterResults table 2755 representing the query hits for that particular filter or combination of filters and/or sub-filters. Those students may be combined by means of a union (when the active filter list has is All=False) or an intersection (when the active filter list has is All=True) and for one or more of each selected student, a row may be created in web_FilterResultsCurrent table 2756 to represent the fact that this student is selected by the active list of filters for the given userId. This table may be updated, as described below.

The relational database may be accessed by a user via the user interface of the system for various actions, including but not limited to, queries, saving filters, saving query results, and for operations, including insert, update and/or delete. One or more operations initiated by a user by means of the user interface may result in either SELECT queries or INSERT, UPDATE, or DELETE operations in the relational database. In at least one embodiment, user-initiated operations may be performed in a web browser. For example, the web browser may send a request to a web server. The web server then may perform the requested operation and send back some HTML to allow the browser to show any changes to the state. The system may be implemented using other technologies, such as a fat client that directly interacts with the database.

In using at least one embodiment of the system, if a user accesses the system for the first time, the web_ . . . tables described with reference to FIG. 27 have no rows associated with that userId. The screen he sees indicates that there are no selected students and no saved filters. (See FIG. 2.) As a side effect of visiting this page for the first time, a row that represents that there is an empty active set of filters is added to web_FilterLists table 2752, as shown in FIG. 28. At this point, all other tables may be empty for this new user.

With this particular embodiment, if a user selects a filter, a row that represents the filter may be added to the web_Filters table 2753 with a filterListId pointing to the user's “Unsaved Group”. The values of the sql, sentence, and is RealTime fields of the new row are filter-dependent. That is, one or more or each filter may be hand-coded to produce the proper values for these fields. Also, each filter may produce a list of parameters. The logic to produce those parameters may also be filter-dependent and hand-coded for one or more or each filter. FIG. 29 shows the results of clicking on a “Enrolled in current term” filter (which has no parameters). The value of the sql field depends on the specific filter and the database structure, but to illustrate, this particular filter generates the following SQL:

select distinct studentId
from fct_StudentTerms st (nolock)
join tbl_CurrentTerm ct (nolock)
on ct.term = st.term
where enrolled = ‘Yes’

This is merely one sample SELECT statement generated by a filter and many other statements may be generated. Claimed subject matter is not intended to be limited to this particular example.

In at least one embodiment, if a user saves a filter, either as a list or as criteria, the record in web_FilterLists table 2752 (FIG. 27) that contains the “Unsaved Group” for the given user may be located. The name of the filter (name field) may be changed to the name chosen by the user. If the user is saving the filter as a list, then the is List field is set to True. Finally, a brand new “Unsaved Group” record is created for the given user.

User initiated operations or events may trigger an update routine or algorithm to update certain filters, query results or other information reading system operations. For example, the following user-initiated operations or events may result in one or more updates to web_FilterResults table 2755 (FIG. 27).

First, selection of a filter (other than a “Saved List” filter) may trigger an update. Second, selection of the negation control for a filter. The second event may happen if a user clicks on the negation control (“do/don't” toggle switch or other selection means, modes or manners for communicating with a computing platform) for a filter that has already been selected.

Third, execution of the ETL process. This may happen if the database in question is a data warehouse. In a data warehouse, there is usually a set of tables that remain static and only change when the ETL process runs. If a filter fully depends on such static tables, then it is only necessary to recalculate the set of selected entries (students in this example) immediately after the ETL process runs. This optimization is not required, but if performed, the system may be much more responsive. Filters that fully depend on those static tables are marked as non-real-time (is RealTime=False). When the database is the backing store for an OLTP system, then all tables can change at any time (is RealTime=True for all filters) and there is no ETL process.

Next, an update may occur if there is a refresh of the main navigator page when one or more of the active filters is marked as real-time filters (is RealTime=True). Similarly, an update may occur if there is election of a “Saved Criteria” filter when one or more of its constituent filters are marked as real-time filters (is RealTime=True). These events are related to filters that are marked as real-time which may depend on at least one table whose contents can change at any moment, so those are executed whenever the user refreshes the navigator page. Because the selection of a “Saved Criteria” filter (or any filter) triggers a refresh of the navigator page, the “Saved Criteria” event is not treated especially but is enumerated above to emphasize that it may require a recalculation of rows in web_FilterResults table 2755 (FIG. 27).

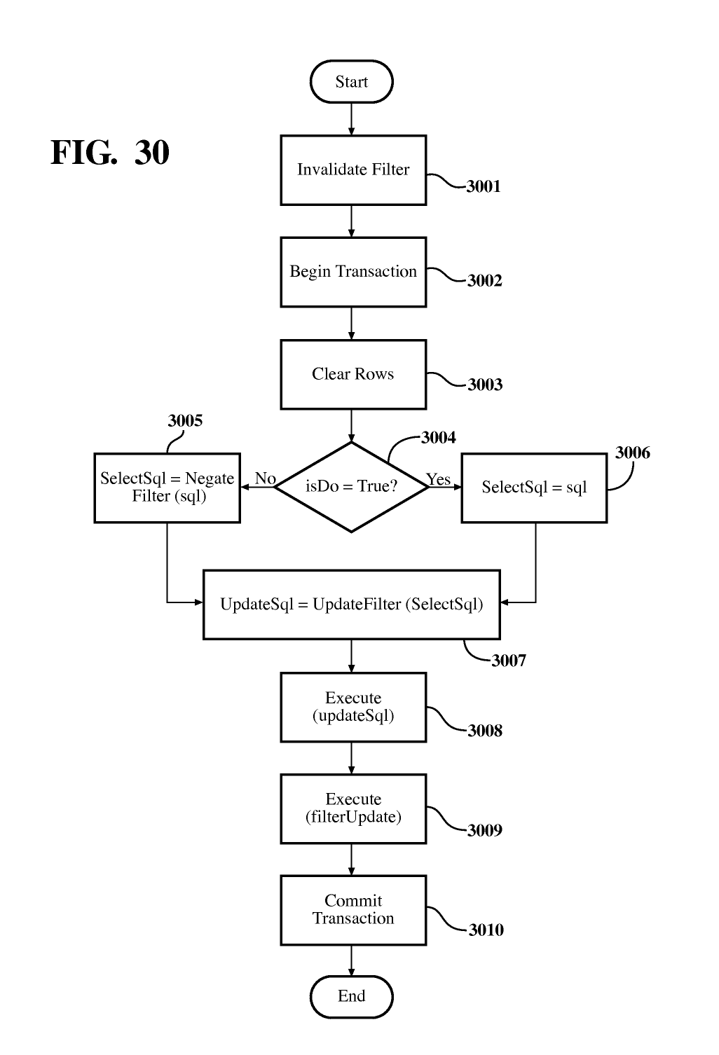

In order to update, one or more embodiments may employ the process described in FIG. 30. Step 3001, invalidateFilter( ) depicts that the system may execute the following SQL where “?” is a parameter marker for the filterId being updated. This marks the filter as invalid in case it fails to run:

update web_Filters

### set is Valid=0

where filterId=?

Next, step 3002 shows that beginTransaction( ) may start a new SQL transaction, such as but not limited to, to ensure that either one or more or all the statements up the commitTransaction( ) run and/or everything is rolled back.

Next, step 3003 shows that clearRows( ) executes the following SQL where “?” is a parameter marker for the filterId being updated. This deletes all rows in web_FilterResults table 755 that relate to the filter being updated:

delete from dbo.web_FilterResults
where filterId=?

Next, decision step 3004 is Do=True? Indicates that the system checks to see if the is Do flag for the filter is True. That is, is the “do”/“don't” toggle switch set to “do”? If “Yes”, then at step 3006 selectSql=sql the system will assign the SELECT statement for the filter (the sql field) to the variable selectSql.

If “No”, then at step 3005 selectSql=negateFilter(sql) the system will apply the negateFilter function to the SELECT statement for the filter (the sql field) and assign the result to the variable selectSql. The negateFilter function converts the <sql> into the following statement:

select studentId
from tbl_Students (nolock)
where studentId not in (

<sql>

)

Again, this is merely one possible example of a particular syntax and method for updating queries, variables, results and the like with an embodiment of the present system.

To implement the negation control with at least one embodiment, there is an assumption that a table exists that can be used to represent the universal set. The table (called tbl_Students in one embodiment) may contain one record for each known student, so it serves the purpose of the universal set. The preceding statement in effect returns the complement of all the students selected by the <sql> generated by the filter. The <sql> is maintained in web_Filters table 2753 (FIG. 27) as the sql field even when the negation control is activated. The select statement in the particular syntax example described above may be used instead of the original statement to update web_FilterResults table 2755 (FIG. 27).

Next, at step 3007, updateSql=updateFilter(selectSql), the system may apply the updateFilter function to the selectSql variable calculated in steps 3005 or 3006. UpdateFilter converts the <selectSql> into the following statement where “?” is a parameter marker for the filterId being updated:

insert into dbo.web_FilterResults

(filterId, studentId)

select ?, tInsert.studentId
from (

<selectSql>

) tInsert

Next, step 3008 shows that at execute(filterUpdate), the preceding INSERT statement is executed. At step 3009 execute(filterUpdate), the following filterUpdate statement is executed where “?” is a parameter marker for the filterId being updated. This marks the filter as updated now and as still being valid:

update dbo.web_Filters
set lastUpdate = getdate( ),

isValid = 1

where filterId = ?

Finally, at step 3010, commitTransaction( ) the transaction is committed.

Similarly, web_FilterResultsCurrent table 2756 (FIG. 27) may be updated in at least one embodiment if: a filter is added to the “Unsaved Group” filter list; a filter is removed from the “Unsaved Group” filter list; a filter in the “Unsaved Group” filter list is toggled between “do” and “don't”; and/or a real-time filter in the “Unsaved Group” is recalculated.

As a simplification, the update can simply take place if the navigator is refreshed in the browser. With either approach, the following algorithm, by way of example, may be applied after or immediately after the possible update to web_FilterResults table 2755 (FIG. 27) is performed. The algorithm may apply to a single user and, therefore, to a single filterListId. That is, the filterListId of the “Unsaved Group” filterList for the given user. That is, the active filter list may clear the rows in web_FilterResultsCurrent table 2756 (FIG. 27) for the given user where “?” is a parameter marker for the userId:

delete from dbo.web_FilterResultsCurrent
where userId=?

Next, one or more rows may be inserted in web_FilterResultsCurrent table 2756 (FIG. 27) for the given user. This statement has three parameter markers (“?”). The corresponding parameters are the userId, the filterListId, and counter. The counter may be calculated as follows: If the any/all switch for the filterList is set to “any”, then counter=1. If it set to “all”, then it is set to the number of filters in the filterList:

insert into dbo.web_FilterResultsCurrent

(userId, studentId)

select ?, sfr.studentId
from web_FilterResults sfr
join web_Filters sf
on sf.filterId = sfr.filterId
where sf.filterListId = ?
group by sfr.studentId
having count(distinct sfr.filterId) >= ?

If a user selects a saved filter (as discussed with reference to FIG. 9 above), this action may be treated like any other filter. In one or more embodiments, one or more or every filter may be hard-coded, and if selected, the code for that filter may generate: a sentence to display in the user interface; sql to execute to retrieve the set of selected query hits (students in this example); a possible empty list of parameters; and an is RealTime flag which is set to true if any of the tables used to generate the filter are real-time. The sentence may be “appear in saved filter <name>” where <name> is the name of the saved filter. The sql may be set, for example, to the following value (where “?” is a parameter marker):

select studentId
from web_FilterResults sfr
join web_Filters sf
on sf.filterId = sfr.filterId
where filterListId = ?
group by sfr.studentId
having count(distinct sfr.filterId) >= ?

The list of parameters may be, for example, the filterListId of the saved filter (all saved filters are filter lists), and a counter, which is 1 if the saved filter list has is All=False or the number of filters in the filterList if the saved filterList has is All=True. The is RealTime flag is set to True if any of the filters in the filterList has is RealTime=True and the filterList has is List=False; otherwise is RealTime is False. Of course, this is merely one possible embodiment for implementing the system, methods and user interface described herein, and claimed subject matter is not intended to be so limited.

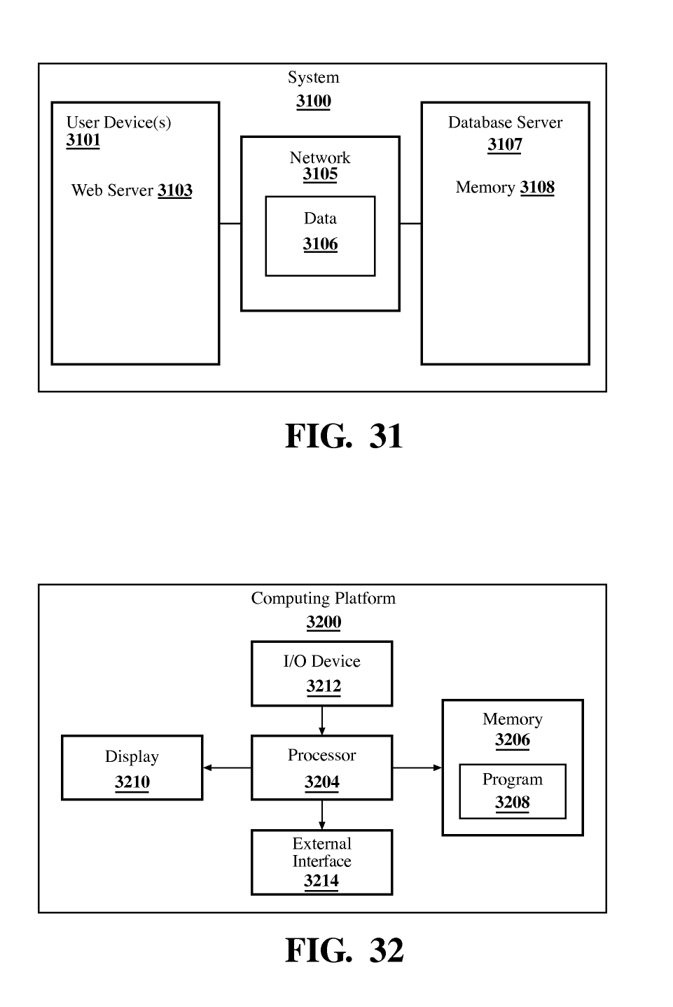

FIG. 31 shows a system that may be used in accordance with one or more embodiments of the system, methods and user interface disclosed in this application.

System 3100 includes one or more user devices 3101, which may be used to input data 3106, such as query information, filter information, parameter information and/or database information. User device 3101 may be a computing platform, as described in this application, such as a computing device, desktop computer, laptop computer, tablet, mobile device, handheld device, PDA, cellular device, smartphone, scanner or any other device known in the art that is capable of inputting data 3106. User device 3101 may be capable of accepting user input data, such as query selection information, filter and/or parameter information, and database information, as described above. User device 3101 may be used to upload data 3106, such as query, filter and/or parameter information, to a server 3107 via network 3105. System 3100 further includes web server 3103, which may be used to communicate with database server 3107 over network 3105. Network 3105 may be any combination of wired and/or wireless LAN, cellular and/or internet communications and/or other local and/or remote communications networks known in the art.

User device 3101 capable of computing, running, updating and/or saving one or more queries, and/or create and/or update one or more filters and/or parameters, as described with respect to FIGS. 1-30. In other embodiments, these functions may be performed by database server 3107 and/or memory 3108. User device 3101 may be capable of receiving data 3106 from database server 3107 and computing one or more queries, filters and/or parameters based at least in part upon the data 3106 received. Database server 3107 may also have memory 3108 in one or more embodiments. Memory 3108 may be any type of local, remote, auxiliary, flash, cloud or other memory known in the art. Data 3106 may include, at least in part, one or more database items, query information, filters and/or parameters. In some embodiments, user device 3101 may send data 3106 to database server 3107 via network 3105 for storage in memory 3108, such as queries, filters, parameters, system user information, database item information or other information. Such data 3106 may include one or more saved queries, filters or parameters. Claimed subject matter is not intended to be limited to this particular system embodiment described in FIG. 31.

Referring to FIG. 32, a block diagram of a computing platform 3200, such as that used in system 3100 described with reference to FIG. 31 above, which may be used with the system, methods and user interface described herein according to one or more embodiments is illustrated, although the scope of claimed subject matter is not limited in this respect. Computing platform 3200 may include more and/or fewer components than those shown in FIG. 32; however, generally conventional components may not be shown, for example, a battery, a bus, and so on.

Computing platform 3200, as shown in FIG. 32, may be utilized to embody tangibly a computer program and/or graphical user interface by providing hardware components on which the computer program and/or graphical user interface may be executed. Computing platform 3200 may be utilized to embody tangibly all or a portion of FIGS. 1-31 and/or other procedures disclosed herein. Such a procedure, computer program and/or machine readable instructions may be stored tangibly on a computer and/or machine readable storage medium such as a compact disk (CD), digital versatile disk (DVD), flash memory device, hard disk drive (HDD), and so on. As shown in FIG. 32, computing platform 3200 may be controlled by processor 3204, including one or more auxiliary processors (not shown). Processor 3204 may comprise a central processing unit such as a microprocessor or microcontroller for executing programs, performing data manipulations, and controlling the tasks of computing platform 3200. Auxiliary processors may manage input/output, perform floating point mathematical operations, manage digital signals, perform fast execution of signal processing algorithms, operate as a back-end processor and/or a slave-type processor subordinate to processor 3204, operate as an additional microprocessor and/or controller for dual and/or multiple processor systems, and/or operate as a coprocessor and/or additional processor. Such auxiliary processors may be discrete processors and/or may be arranged in the same package as processor 3204, for example, in a multicore and/or multithreaded processor; however, the scope of the scope of claimed subject matter is not limited in these respects.

Communication with processor 3204 may be implemented via a bus (not shown) for transferring information among the components of computing platform 3200. A bus may include a data channel for facilitating information transfer between storage and other peripheral components of computing platform 3200. A bus may further provide a set of signals utilized for communication with processor 3204, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including IEEE 488 general-purpose interface bus (G FIB), IEEE 696/S-100, and so on, although the scope of the scope of claimed subject matter is not limited in this respect.

Other components of computing platform 3200 may include, for example, memory 3206, including one or more auxiliary memories (not shown). Memory 3206 may provide storage of instructions and data for one or more programs 3208 to be executed by processor 3204, such as all or a portion of FIGS. 1-30 and/or other procedures disclosed herein, for example. Memory 3206 may comprise, for example, semiconductor-based memory such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Alternatively or additionally, memory 3206 may comprise, for example, magnetic-based memory, such as a magnetic disc memory, a magnetic tape memory, and/or the like; an optical-based memory, such as a compact disc read write memory, and/or the like; a magneto-optical-based memory, such as a memory formed of ferromagnetic material read by a laser, and/or the like; a phase-change-based memory such as phase change memory (PRAM), and/or the like; a holographic-based memory such as rewritable holographic storage utilizing the photorefractive effect in crystals, and/or the like; a molecular-based memory such as polymer-based memories, and/or the like; and/or a remote or cloud based memory and/or the like. Auxiliary memories may be utilized to store instructions and/or data that are to be loaded into memory 3206 before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memories also may include any type of non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well.

Computing platform 3200 further may include a display 3210. Display 3210 may comprise a video display adapter having components, including, for example, video memory, a buffer, and/or a graphics engine. Such video memory may comprise, for example, video random access memory (VRAM), synchronous graphics random access memory (SCRAM), windows random access memory (WRAM), and/or the like. Display 3210 may comprise a cathode ray-tube (CRT) type display such as a monitor and/or television and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth. Display 3210 may be used to view the user interface described with reference to FIGS. 1-26 above.

Computing platform 3200 further may include one or more I/O devices 3212. I/O device 3212 may comprise one or more I/O devices 3212 such as a keyboard, touch screen, stylus, electroacoustic transducer, microphone, speaker, audio amplifier, and/or the like.

Computing platform 3200 further may include an external interface 3214. External interface 3214 may comprise one or more controllers and/or adapters to prove interface functions between multiple I/O devices 3212. For example, external interface 3214 may comprise a serial port, parallel port, universal serial bus (USB) port, charge coupled device (CCD) reader, scanner, compact disc (CD), compact disk read-only memory (CD-ROM), digital versatile disc (DVD), video capture device, T tuner card, 802×3 devices, and/or IEEE 1394 serial bus port, infrared port, network adapter, printer adapter, radio-frequency (RF) communications adapter, universal asynchronous receiver-transmitter (UART) port, and/or the like, to interface between corresponding I/O devices 3212. Claimed subject matter is not intended to be limited to this particular embodiment of a computing platform 3200 that may be used with the system, user interface and methods described herein.

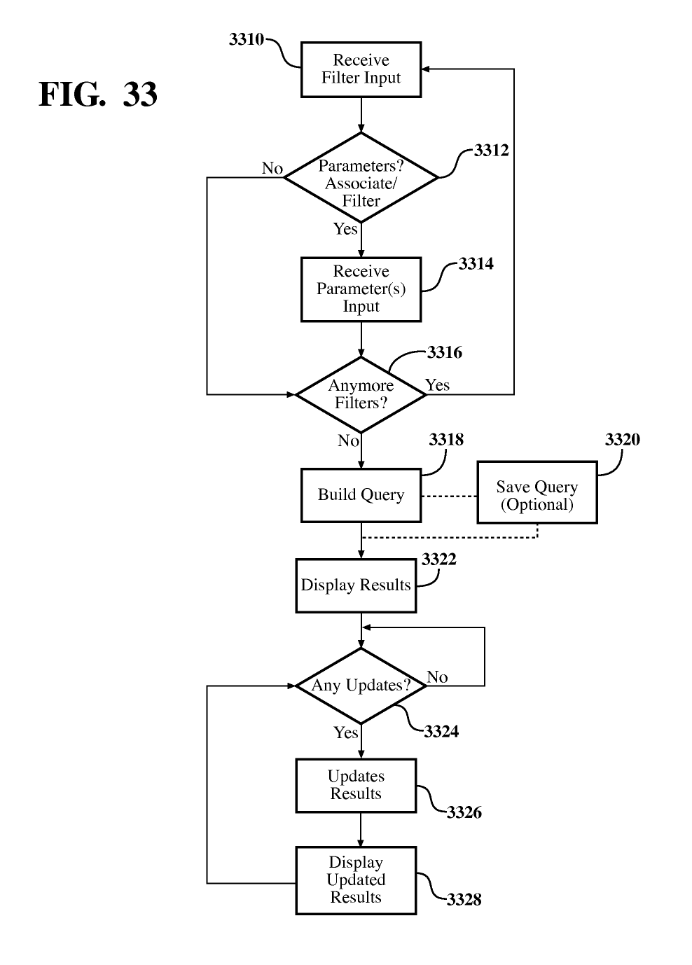

Referring now to FIG. 33, a method of building a query is shown. Block 3310 shows that the system may receive a filter that has been input by a user. A user may select from available filters and/or create a unique filter, as described above with reference to FIGS. 1-26. At diamond 3312, the system inquires as to whether there are one or more parameters associated with the received filter. If there are one or more parameters associated with the selected filter, at block 3314, the system is capable of receiving one or more parameter inputs which may serve to limit or set one or more boundaries of the selected filter, as described above with reference to FIGS. 1-26. Depending upon the filter selected, the existence of, type, number and kind of associated parameters may vary. If there are no associated parameters, the flow moves to diamond 3316. Diamond 3316 depicts that the system inquires as to whether there are any other filters selected. If there are further filters, flow moves back to block 3310, and the parameter inquiry process shown in diamond 3312 and block 3314 is repeated for each filter. Block 3318 depicts that a query is built using the selected filter(s) and parameter(s). Block 3320 shows the optional act of saving the search, which may be accomplished as described above with reference to FIG. 9. Block 3322 shows that the query results are displayed. Diamond 3324 displays the inquiry as to whether any updates are received for the query. Updates may include input, such as but not limited to, negation controls, “any/all” toggles, added or deleted filters and/or parameters, newly added database items, time, and the like. If one or more updates are received, block 3326 shows that the query is updated in accordance with the change(s). Block 3328 shows that the updated results are displayed. In this manner, a user may custom build a search with pre-set and unique filters and/or parameters and then modify the search by using functionality, including but not limited to, negation controls, “any/all” toggles, adding or deleting filters and/or parameters, without having to rebuild the entire search. Further, search results displayed may be modified by sql controls and the like.

In the present system, the mechanism to efficiently find sets of students may be combined with a reporting facility. Yet, instead of allowing users access to a menu of reports, the present system decouples the selection of students included in a report from the selection of the report itself, this decoupling allows a report to apply to any set of selected students, multiplying the choices available to the user. For example, a report that shows the breakdown of students by age and ethnicity can be applied to students enrolled in a specific major, or taking a specific set of classes, or can be used to contrast students enrolled in evening classes or online classes and the general student population. The customizable filter functionality assists to make this possible. Further, the reporting mechanism may work with future built filters, combinations of filters and queries. In this sense, the system may have extensibility characteristics.

In order to apply a report to the set of selected students, when the user selects a report in the present system, the report is executed and shown in the browser. The report's execution may follow the same strategy as substantially any report generated by a platform used to generate reports, and used or integrated with the present system. In fact the reports may be designed and exposed on the web using any number of custom-made, commercial, or open source reporting tools, such as Microsoft Reporting Services, Crystal Reports, etc. The only change needed to have the report apply to the students selected in the navigator is to restrict the SELECT statement used to generate the report's data. In this particular example, these are all student reports, so the SELECT statement contains information related to students. But many other applications and examples are possible within the scope and spirit of this application. In this example, at some level, data is extracted from some student-related table, such as but not limited to, student-terms, student-classes, student-tests, student-degrees, student-financial-aid-awards, etc. One or more or all of these tables may have a studentId field, which may be used to tag or coordinate table and/or report information to one or more students. The report may have an arbitrarily complex SELECT statement that includes, in at least one table, a studentId field. Wherever the student-related table appears, that portion of the SELECT statement may be converted into something like this, by way of example:

select <arbitrary list of fields from t>
from <some-student-related-table> as t
join web_FilterResultsCurrent as f
on f.studentId = t.studentId
and f.userId = <the-userId-of-the-person-requesting-this-report

This INNER JOIN may have the effect of restricting the set of students included in the report to just those that are selected in the navigator by the user that requests the particular report.

It will, of course, be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as one or more SD cards and/or networked disks, for example, may have stored thereon instructions that if executed by a system, such as a computer system, computing platform, or other system, for example, may result in the system performing techniques database querying and/or displaying a user interface in accordance with claimed subject matter. Such techniques may comprise one or more of the example embodiments described herein, for example.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A computer implemented method of building a customized query for a database comprising:
providing one or more database search filters capable of providing at least one criteria for filtering items in a database;
providing one or more parameters capable of being associated with said one or more filters, wherein said one or more parameters are capable of defining at least one boundary criteria for said one or more associated filters;
combining two or more said filters and associated parameters to build a multilayered database query in response to at least two said filters and said associated one or more parameters being selected;
displaying results for said multilayered database query on a computing platform, wherein said results comprise one or more said items in said database which meet said criteria for said filters and said boundary for said one or more parameters;
modifying said results without rebuilding said query, in response to combining one or more said other filters and said one or more associated parameters or deselecting one or more said filters and/or said one or more said associated parameters.

2. The computer implemented method of claim 1 further comprising generating one or more reports to display said results based at least in part upon said one or more selected filters and/or said one or more associated parameters.

3. The computer implemented method of claim 2 wherein said report comprises one or more complex filters comprising two or more filters and associated parameters.

4. The computer implemented method of claim 3 wherein said report comprises one or more table filters.

5. The computer implemented method of claim 1 further comprising providing one or more negation controls, wherein said negation controls are capable of changing said one or more criteria and/or said boundary criteria to an opposing value.

6. The computer implemented method of claim 1 further comprising providing any/all functionality capable of modifying query results to include results meeting any of said criteria and said boundary criteria or results meeting all of said criteria and said boundary criteria.

6. The computer implemented method of claim 1 further comprising providing a complex filter, wherein said complex filter comprises two or more said filters and two or more said associated parameters.

7. The computer implemented method of claim 6 wherein said complex filter is a table filter.

8. The computer implemented method of claim 1 further comprising saving said query criteria and said boundary, wherein said saved query is capable of being used as a said filter.

9. The computer implemented method of claim 1 wherein said database contains student information.

10. The computer implemented method of claim 1 further comprising combining one or more said filter and associated parameter to said multilayered database query to provide secondary criteria for filtering said results.

11. An article comprising: a storage medium having stored thereon instructions that, if executed, enable a computing platform to:
provide two or more database search filters capable of providing at least one criteria for filtering items in a database;
provide one or more parameters associated with at least one of said filters, wherein said one or more parameters are capable of defining at least one boundary criteria of said associated filters;
combine two or more said filters and said parameters to build a multilayered database query in response to at least two said filters and said associated parameters being selected;
display results for said multilayered database query on said computing platform, wherein said results comprise one or more items in said database which meet said criteria and boundary criteria;
modify said results without rebuilding said query, in response to adding or deleting said one or more said filters and/or said one or more parameters; and
save said multilayered query criteria and boundary criteria as a complex filter.

12. The article of claim 11 further comprising instructions, which if executed, enable said computing platform to generate a report based at least in part upon said complex filter, and wherein said report may be selected for other said multilayered queries to display database items meeting said criteria for said complex filter.

13. The article of claim 11 further comprising instructions, which if executed, enable said computing platform to provide one or more negation controls capable of changing said one or more criteria to an opposing value.

14. The article of claim 11 further comprising instructions, which if executed, enable said computing platform to provide any/all functionality capable of modifying query results to include results meeting any of said criteria or results meeting all of said criteria.

15. The article of claim 11 further comprising instructions, which if executed, enable said computing platform to provide a table filter, wherein said table filter comprises a multi-layered filter having two or more said filters and two or more said associated parameters.

16. A database query user interface displayable on a computing platform comprising:
one or more filters capable of being applied as criteria to filter entries in a database in a database query, wherein said filters are capable of being customized;
one or more parameters capable of being selected and associated with said one or more filters, wherein said parameters are capable of limiting said criteria for at least one boundary of said associated filter;
a field for displaying results from a database query, wherein said results include one or more said entries meeting said filter criteria and fitting within said at least one boundary of said filter;
one or more negation controls capable of being selected to change said criteria and said at least one boundary to an opposing value;
one or more any/all controls capable of being selected to modify query results to include results meeting any of said criteria and said at least one boundary or results meeting all of said criteria and said at least one boundary;
a field for displaying active filters selected for filtering said database; and
at least one search field capable of receiving alphanumeric typed input for searching said filters.

17. The user interface of claim 16 further comprising one or more sub-filters capable of filtering said results by applying secondary criteria for filtering said results and capable of being associated with one or more said parameters to define at least one boundary of said secondary criteria.

18. The user interface of claim 16 further comprising a save control capable of saving said search results as said criteria and said at least one boundary, wherein said saved search is capable of being used as a said filter.

19. The user interface of claim 16 further comprising one or more cardinalities associated with said active filters for displaying database entries meeting said criteria and boundary for said active filter.

20. The user interface of claim 16 further comprising saved search information capable of being displayed and comprising a search description, a search name and said active filters and said parameters of said saved search.

21. The user interface of claim 16 further comprising a table filter, wherein said table filter comprises two or more filters having said one or more parameters associated thereto, wherein said parameters are selected from the group consisting essentially of a relational parameter, a time parameter, a date parameter, a fixed list parameter and an alphanumerically typed parameter.

22. The user interface of claim 16 wherein said two or more filters and said at least one parameter are comprised of natural language and have associated SQL statements capable of being used by said computing platform for using said filters and said parameters for querying said database.

23. The user interface of claim 16 further comprising a reporting control capable of saving or displaying reports based at least in part upon a selection of said two or more filters and associated parameters.

24. A multi-layered student database query system comprising:
two or more filters capable of being used to provide at least two criteria for filtering student database entries in a database containing student information and capable of being queried,
two or more parameters capable of being associated with said two or more filters, wherein said two or more parameters are each capable of defining at least one boundary criteria for one said associated filter;
one or more negation controls capable of being selected to change said criteria and said at least one boundary to an opposing value;
one or more any/all controls capable of being selected to modify query results to include results meeting any of said criteria and said at least one boundary or results meeting all of said criteria and said at least one boundary;
a display for displaying results of a multi-layered database query on a computing platform, wherein said results comprise one or more said student entries in said database which meet said criteria for said filters and said boundary for said parameters;
a processor adapted to query said student database in a multi-layered database query in response to at least said filters and said associated parameters being selected;
wherein said query is adapted to be modified without rebuilding said query, in response to adding or deleting one or more said filters and/or one or more said parameters; and
memory adapted to have stored therein said filters, said parameters and a saved search, wherein said saved search comprises said query criteria and said at least one boundary and may be used as a said filter.

25. The system of claim 24 further comprising a student database for storing student data as database entries and capable of being queried.

26. The system of claim 24 further comprised of one or more complex queries comprising two or more said filters and said associated parameters, wherein said complex queries are capable of being saved as a said filter and combined with one or more other said filters in said multi-layered database query.

27. The system of claim 24 further comprising one or more reports generated by said processor which are based at least in part upon said filters and which may be applied to other said queries.
